(19) United States
(12) Patent Application Publication
(10) Pub. No.: US 2025/0085098 A1
(43) Pub. Date: Mar. 13, 2025

(54) WEARABLE ARTICLE SYSTEM WITH STRETCH SENSORS

(71) Applicant: NIKE, Inc., Beaverton, OR (US)

(72) Inventors: Christopher Andon, Portland, OR (US); Samantha J. Hultgren, Portland, OR (US); Stephen H. Udumalagala, Santa Clara, CA (US)

(21) Appl. No.: 18/827,364

(22) Filed: Sep. 6, 2024

Related U.S. Application Data
(60) Provisional application No. 63/537,366, filed on Sep. 8, 2023.

(51) Int. Cl. G01B 7/16; A41D 1/00

(52) U.S. Cl. CPC G01B 7/16; A41D 1/002

(57) ABSTRACT

Aspects herein are directed to a wearable article system and methods for determining, among other things, a fit suitability associated with a wearable article based on sensor data received from stretch sensors incorporated into the wearable article. Such wearable article and associated functionality improves the existing technologies. In some aspects, the wearable article includes multiple conductive threads or traces that act as stretch sensors because they can, for example, change resistance when stress or strain is applied. A trace can be a conductive element that is configured to convert mechanical stimuli into one or more electric signals. The wearable article is configured to conform to a human body part.

### CROSS-REFERENCE TO RELATED APPLICATIONS

This application claims priority to U.S. Provisional Patent Application No. 63/537,366, entitled “Wearable Article System with Stretch Sensors,” filed Sep. 8, 2023, which is incorporated by reference in its entirety.

### FIELD

Aspects herein relate to systems and methods for determining, among other things, a fit suitability associated with a wearable article based on sensor data received from stretch sensors incorporated into the wearable article.

### BACKGROUND

Some organizations specifically design and manufacture apparel, such as footwear, for particular individuals. Such specific design and manufacture depend on comfort level of the individuals when wearing the apparel, size of a body part to fit into the apparel, aesthetic preferences of the individuals, or other attributes. However, existing technologies for measuring such attributes, such as apparel fit or footwear sizing, are static in design and functionality. Moreover, these technologies require using bulky equipment, such as cameras, imagers, and other lab equipment.

### BRIEF DESCRIPTION OF THE DRAWINGS

The present technology is described in detail herein with reference to the accompanying drawings, which are described below.

FIG. 1A illustrates, at a high level, a sock structure with stretch sensors that are configured to convert mechanical stimuli into electrical signals and transmit corresponding sensor data to one or more network devices, such as a smartwatch, according to some aspects.

FIG. 1B illustrates a shoe recommendation for the wearer of FIG. 1A based on sensor data derived from the sock structure and based on the wearer basketball activity, according to some aspects.

FIG. 2 illustrates a presented fit score for a wearer based on sensor data derived from a sock structure, according to some aspects.

FIG. 3 illustrates, at a high level, a side view of a sock structure that conforms to a lower limb of a wearer, according to some aspects.

FIG. 4 illustrates, at a high level, a front view of a head covering that conforms to the head of a wearer, according to some aspects.

FIG. 5 illustrates a closer view of a portion of the sock structure of FIG. 3, according to some aspects.

FIG. 6 illustrates where sets of traces are located in correspondence with a human foot, according to some aspects.

FIG. 7A is illustrates a map of measurement or sensor data provided by each trace of a sock structure, according to some aspects.

FIG. 7B illustrates a three-dimensional model of a human foot based on the map of sensor data of FIG. 5A, according to some aspects.

FIG. 8 illustrates different sizes and patterns of a sock structure from different views, according to some aspects.

FIG. 9A illustrates a sock structure in relation to a shoe at heel strike and corresponding capacitive sensor values, according to some aspects.

FIG. 9B illustrates the sock structure of FIG. 9A in relation to the shoe at heel-off and corresponding capacitive sensor values, according to some aspects.

FIG. 10 is a schematic diagram illustrating how a neural network generates scores indicative of fit, comfort, and/or shoe recommendations, according to some aspects.

FIG. 11 is a screenshot of an example user interface, according to some aspects.

FIG. 12 is a flow diagram of an example process for determining and sending stretch sensor data, a visual, and/or a score, according to some aspects.

FIG. 13 is a flow diagram of an example process for causing presentation of a display element or score based on processing one or more streams of near-real-time stretch sensor data, according to some aspects.

FIG. 14 is a flow diagram of an example process for determining fit or other attributes associated with a wearable article, according to some aspects.

FIG. 15 is a flow diagram of an example process for transmitting stretch sensor data representing electrical signals to a network device for further processing, according to some aspects.

FIG. 16 is a flow diagram of an example process for determining a resistance value for each trace based on a voltage, according to some aspects.

FIG. 17 is a flow diagram of an example method of manufacturing a wearable article, according to some aspects.

FIG. 18 is a block diagram illustrating an example computing environment for determining fit or other attributes associated with a wearable article, according to some aspects.

FIG. 19 is a sequence diagram illustrating a wearable article, a remote device, and a user device performing different functionalities, according to some aspects.

FIG. 20 is a sequence diagram illustrating a wearable article and a remote device performing different functionalities, according to some aspects.

FIG. 21 is a sequence diagram illustrating a wearable article and a user device performing different functionalities, according to some aspects.

FIG. 22 is a block diagram of electronics of any wearable article described herein, according to some aspects.

FIG. 23 is a block diagram of a computing device, according to some aspects.

### DETAILED DESCRIPTION

### Overview

Existing solutions require certain individuals (e.g., high-profile athletes) to travel to a lab that contains bulky equipment (e.g., cameras and imagers) for footwear sizing or measuring other attributes. Alternatively, some solutions require moving such bulky equipment to the location of the individuals. Both of these processes are not only costly and waste time, the technologies used in these solutions are static in design and functionality. For example, some surface imaging systems includes a stereo head (for stereo vision) that contains multiple cameras and projectors. Such cameras are used to capture images of the human body from different perspectives. The projectors are used to cast a random speckle pattern onto the human body to create an artificial texture for surface reconstruction of the whole body. However, using this technology requires tedious setup and configuration (e.g., mounting and wiring complicated stereo cameras and projectors). Moreover, these and other technologies (e.g., imagers) only capture a surface level reconstruction of a body and do not, for example, indicate internal granular-level deformation characteristics of various portions of the apparel based on human movement, such as stretch, compression, pressure, torsion, bending, shear, or other internal forces, which may indicate comfort level or fit, among other things.

At a high level, aspects herein are directed to a wearable article system and methods for determining, among other things, a fit suitability associated with a wearable article based on sensor data received from stretch sensors incorporated into the wearable article. Such functionality and wearable article improve the existing technologies described above, as well as other technologies.

In some aspects, the wearable article (e.g., a sock structure) includes multiple conductive threads or traces that act as stretch sensors (e.g., a capacitive sensor, a resistive sensor, and a piezoresistive sensor) because they can, for example, change resistance when stress or strain is applied. A “trace” is any suitable signal carrier and conductive element that is configured to convert mechanical stimuli (e.g., stress, strain, or deformation) into one or more electric signals (e.g., resistance values, dielectric values, etc.). The wearable article is configured to conform to a human body part (e.g., a foot, a head, a hand, a torso).

In some aspects, a processor (e.g., a microprocessor or microcontroller) is communicatively coupled to the stretch sensors. In some aspects, the processor is configured to perform various operations. For example, the processor can receive, at a first time, first sensor data via the stretch sensors. The first sensor data indicates a first sensor value (e.g., ohm value X) of each trace. The wearable article is in a first position (e.g., indicating heel strike gait of the wearer) at the first time. Some aspects receive, at a second time subsequent to the first time, second sensor data via the stretch sensors. The second sensor data indicates a second sensor value (e.g., ohm value Y) of each trace. The wearable article is in a second position (e.g., indicating heel-off gait of the wearer) at the second time.

Based at least in part on the first sensor data and the second sensor data, some aspects can then determine various information. For example, some aspects determine a fit suitability associated with the wearable article. In an illustrative example, the wearable article may be a sock structure configured to be worn over a human foot and the sock structure is configured to be placed in an interior volume of space in a shoe. Aspects can determine whether the human foot fits the shoe based on a capacitive sensor detecting an inside portion of the shoe (e.g., via propagating an electric field and detecting changes in an oscillator) and another sensor (e.g., a resistive sensor) detecting deformation characteristics of a corresponding portion of the traces.

In another example, based on the first sensor data and the second sensor data, various aspects determine one or more locations at the traces that have exceeded a sensor data threshold. For example, each trace can be an elongated conductor thread that includes an outer electrode sheath along its length to sense mechanical stimuli and provide corresponding sensor signals along its length. Each trace may be close together and aligned in a “grid” or mesh configuration such that they crisscross, are perpendicular to each other, or otherwise overlap. In this way, particular aspects receive granular location information and internal deformation or other mechanical characteristics, such as precise locations within traces that experience resistance over a threshold. This indicates displacement or other deformation characteristics of that trace or portion of the trace. Various aspects capture such information in near-real-time as the wearer moves their body part. In yet another example, some aspects detect a size or dimensions of the human body part (e.g., a foot) based on the first sensor data and/or the second sensor data.

Based at least in part on such determination (e.g., of a fit), some aspects cause presentation, at a user device, of one or more user elements. For example, some aspects generate a heat map that includes a digital model of the human body part during a time sequence corresponding to the first time and the second time. In some aspects, the heat map further includes an element (e.g., a “hot spot”) that indicates, over the digital model, a location of the traces that has exceeded the sensor data threshold. This, for example, captures the near-real-time indications of which portions at a shoe and/or foot that experiences pressure points over a threshold during a particular video or time sequence. In yet another example, aspects can cause presentation of or more user interface elements that indicate the size or dimensions of the human body part (e.g., a foot).

In various aspects, the presented elements can additionally or alternatively include any other suitable type of information, such as one or more shoe design or shoe selection recommendations for a user to wear based on capacitive sensor detection and resistive sensor detection. In order to provide these and other elements, particular aspects map (e.g., via a data structure or machine learning model) each sensor data value to one or more characteristics, such as shoe design recommendations, comfort levels, or types of forces experienced by the mesh structure (e.g., torsion, bending, compression, etc.). Responsively, some aspects provide indications of such characteristics. For example, some aspects cause presentation, at a user interface, of particular areas in the shoes or wearable article that will likely be less comfortable to the user based on pressure at various traces exceeding a pressure threshold.

### Example Wearable Articles

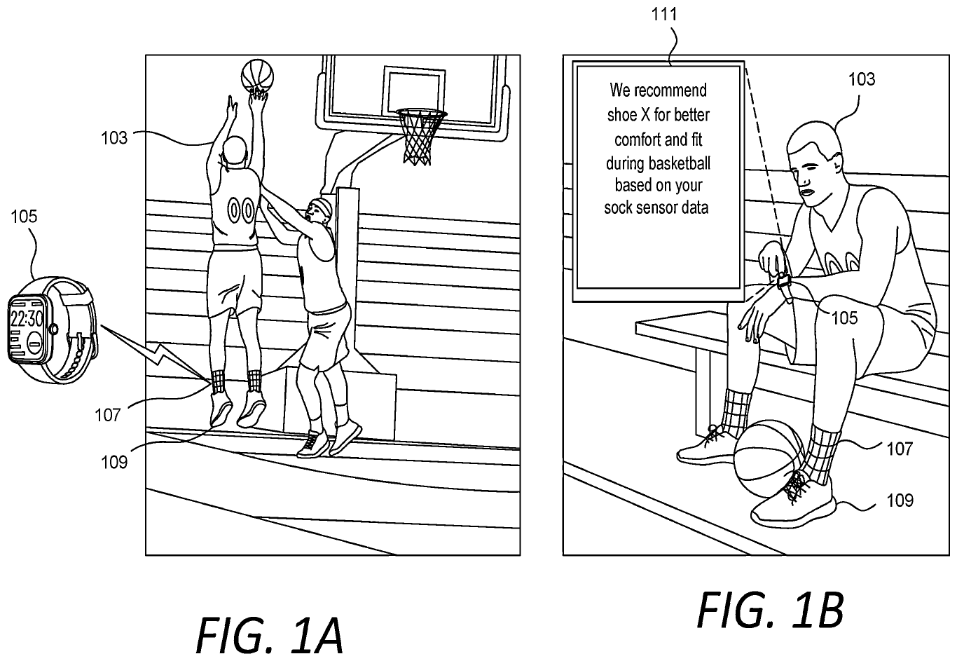

With respect now to the drawings, FIG. 1A illustrates, at a high level, a sock structure 107 with stretch sensors that are configured to convert mechanical stimuli into electrical signals and then transmit corresponding sensor data to one or more network devices, such as a smartwatch 105, according to some aspects. While the wearer 103 is engaged in a basketball activity, each trace (representing a stretch sensor) in the sock structure 107 converts mechanical stimuli (e.g., stress levels as a result of movement of a foot of the wearer 103) into one or more electrical signals (e.g., resistance values). For example, a trace at a bottom heel portion of the sock structure 107 may act as a capacitor sensor that detects, from its sensing end (e.g., its electrode) a distance it is from an upper surface of a corresponding interior heel portion of the shoe 109 by emitting an electrical field. The trace's electrical field disruption characteristics may then be translated into distance. Such sensor readings indicate how closely each portion of the interior portion of the shoe 109 is conforming to corresponding regions of the sock structure 107. Responsively, the sock structure 107 transmits (e.g., via a network communication interface) the sensor data to one or more network devices, such as the smart watch 105, and/or other network devices (e.g., a server, cloud node, or the like).

FIG. 1B illustrates a shoe recommendation 111 for the wearer 103 of FIG. 1A based on sensor data derived from the sock structure 107 and based on the wearer 103's basketball activity, according to some aspects. FIG. 1B illustrates a point in time after which the wearer 103 engaged in the basketball activity illustrated in FIG. 1A. Responsive to a network device receiving the sensor data from the sock structure 107 as described in FIG. 1A, the network device determines one or more visuals and/or scores, as described in more detail herein. For example, a server may generate, via a neural network, a low fit score indicative that the shoe 109 does not fit the foot of the wearer 103 based on the capacitor sensor values corresponding to some portions of the sock structure 107 exceeding a threshold. Responsively, such network device may send the shoe recommendation 107 to the smart watch 105, which states, “We recommend shoe X for better comfort and fit during basketball based on your sock sensor data.” It is understood that the smart watch 105 can be any other alternative user device as described herein, such as a smart phone, smart glasses (AR glasses), a television, or the like. It is also understood, that the activity can be any suitable activity alternative or in addition to basketball, such as running, tennis, soccer, football, or the like.

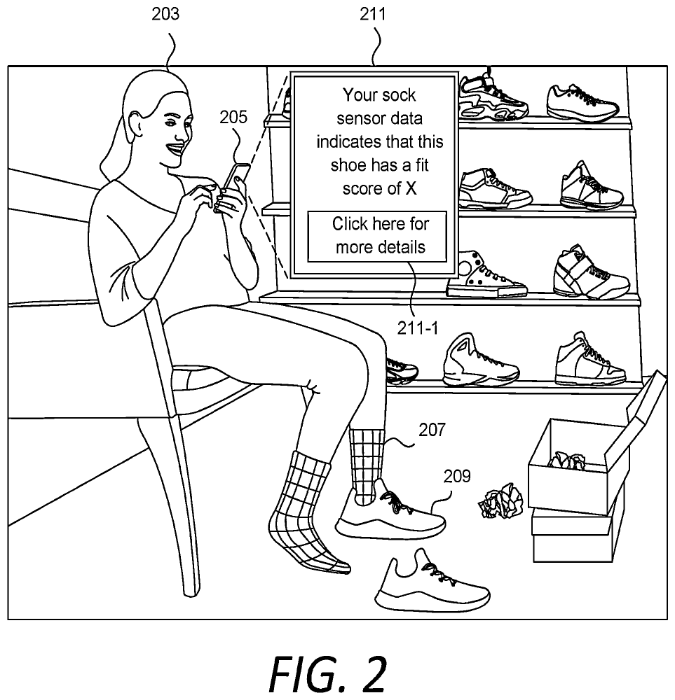

FIG. 2 illustrates a presented fit score 211 for a wearer 203 based on sensor data derived from a sock structure 207, according to some aspects. FIG. 2 further illustrates the wearer 203 trying on a pair of shoes at a retailer. After the wearer 203 has placed their foot and corresponding sock structure 207 into a volume of space representing an interior portion of the shoe 209, each trace in the sock structure 207 converts mechanical stimuli into one or more electrical signals. For example, each trace of the sock structure 207 may act as a resistance sensor that converts displacement or force it experiences to a resistance change. Responsively, the sock structure 207 transmits the sensor data to one or more network devices, such as the smart phone 205, and/or other network devices (e.g., a server, cloud node, or the like).

Continuing with FIG. 2, responsive to a network device receiving the sensor data from the sock structure 207, the network device determines one or more visuals and/or scores, such as a fit score. For example, a server may generate, via a neural network, a low fit score indicative that the shoe 209 does not fit the foot of the wearer 103 based on the resistance values from one or more traces of the sock structure 207 exceeding a threshold. Responsively, such network device may send the fit score to the smart phone 205, which presents the display elements of “Your sock sensor data indicates that this shoe has a fit score of X.” In response to receiving an indication that the user has selected the button 211-1 (“click here for more details”), any other suitable information can be displayed, such as the visual (e.g., a heat map of pressure points on a foot according to the sensor data), the actual resistance sensor values, a model of the foot, and/or a recommended shoe, as described in more detail below. It is understood that the smart phone 205 can be any other alternative user device as described herein, such as a smart watch, smart glasses (AR glasses), a television, or the like.

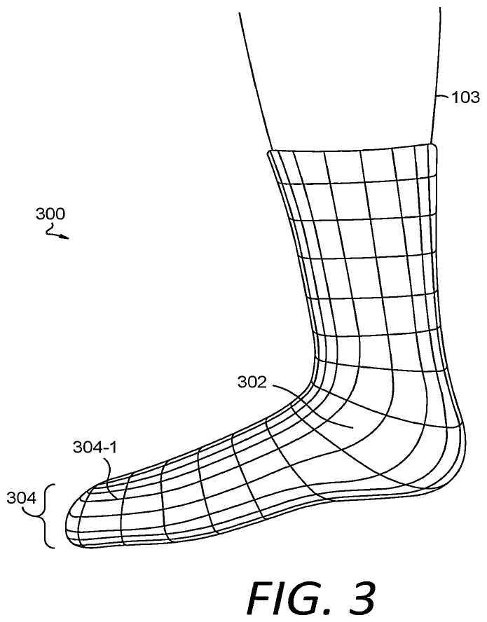

FIG. 3 illustrates, at a high level, a side view of a sock structure 300 that conforms to a lower limb 302 (including a foot) of a wearer, according to various aspects. In some aspects, the sock structure 300 represents the sock structure 107 or 207 of FIG. 1A and FIG. 2 respectively. The sock structure 300 includes a mesh structure 304 that is joined with a fabric outer layer 302 (e.g., via threading the traces of the mesh structure 304 into the fabric outer layer 302). The mesh structure 304 includes multiple individual traces illustrated by individual lines, such as horizontal trace 304-1. As described in more detail below, the sock structure 300 can be used to determine a fit, size, or other information relative to a shoe.

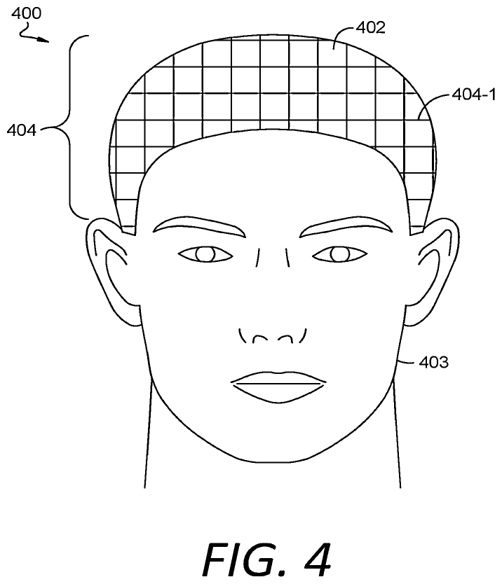

FIG. 4 illustrates, at a high level, a front view of a head covering 400 that conforms to a head 402 of a wearer, according to various aspects. The head covering 400 includes a mesh structure 404 that is joined with a fabric outer layer 402 (e.g., via threading traces of the mesh structure 404 into the fabric outer layer 402). The mesh structure 404 includes individual traces illustrated by the lines, such as horizontal trace 404-1. As described in more detail below, the head covering 400 can be used to determine a fit, size, or other information relative to a sports helmet, hat, or other head dress.

Although FIG. 3 and FIG. 4 describe wearable articles in terms of a sock structure and head covering, it is understood that the wearable article can be any suitable wearable article, such as a glove, an article of footwear (e.g., a sock or a shoe), any suitable garment article (e.g., a brassiere, a shirt, a headband, an arm band, an undergarment, pants, etc.), or a glove. Accordingly, for example, the mesh structure 404 or any other trace configuration described herein can be incorporated into any suitable wearable article.

In some aspects, an article of footwear includes a sole structure secured to an upper. The article of footwear (or any shoe) described herein may comprise a running shoe, a baseball shoe, a basketball shoe, a skateboarding shoe, a cycling shoe, an American football shoe, a tennis shoe, a global football shoe, a training shoe, a walking shoe, a hiking shoe, and the like. The concepts described herein may also be applied to other footwear types that are considered non-athletic such as dress shoes, loafers, sandals, and work boots. As used herein, the article of footwear may be divided into different general regions. A forefoot region generally includes portions of the article of footwear that correspond to the toes and joints connecting the metatarsals with the phalanges. A mid foot region generally includes portions of the article of footwear corresponding with an arch area and an instep area of the foot. A heel region generally corresponds with rear portions of the foot including the calcaneus bone. The article of footwear described herein may include a lateral side which corresponds with an outside area or lateral portion of the foot (i.e., the surface that faces away from the other foot) and a medial side which corresponds with an inside area of the foot (i.e., the surface that faces toward the other foot). The different regions and sides described above are intended to represent general areas of footwear to aid in the following discussion and are not intended to demarcate precise areas. The different regions and sides may be applied to the article of footwear as a whole, to the upper, and to the sole structure.

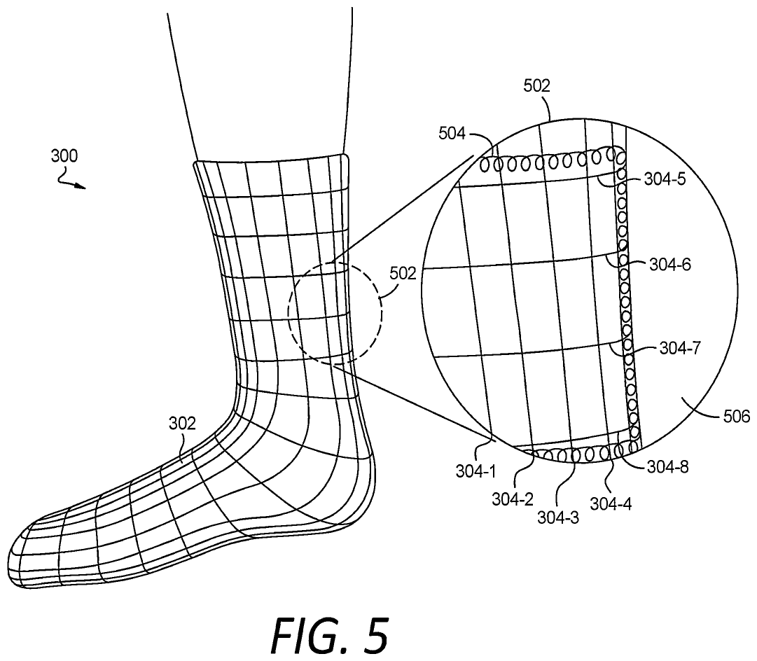

FIG. 5 illustrates an interior view of a portion 502 of the sock structure 300 of FIG. 3, according to aspects. In various aspects, such interior view represents features that are not visible or are underneath the outer fabric layer 302, except for the mesh structure 300, which is visible and is joined to the outer fabric layer 302. The portion 502 includes a base layer 506 (e.g., a stretchable fabric) a set of vertical traces 304-1, 304-2, 304-3, and 304-1, a non-conductive layer 504 (e.g., Thermoplastic polyurethane (TPU)), and a set of horizontal traces 304-5, 304-6, 304-7, and 304-8. A “vertical trace” is a trace that is oriented in a vertical or longitudinal manner. A “horizontal trace” is a trace that is oriented in a horizontal or lateral manner. As illustrated in FIG. 5, the set of vertical traces and horizontal traces are perpendicular to each other such that they form a net or “grid” pattern.

A “grid” pattern has utility in that it is ideal for use with specific sensors, such as resistive and capacitive sensors, as described in more detail below. When portions of the grid pattern (or traces in the grid pattern) are subjected to stress, strain, or force over a threshold, the portion undergoes deformation and leads to a discernable change in its electrical properties (e.g., resistance) at the particular portion, which allows aspects to granularly detect portions of the wearable article (e.g., corresponding to the metatarsal region) that are experiencing deformation characteristics over a threshold. It is understood that although the mesh structure 300 illustrates a grid pattern, there are other suitable patterns, such as serpentine, triangular, diamond, or web-based patterns. In this way, the traces can be positioned and joined to fabric in any suitable orientation. Regarding a “serpentine” pattern, each trace is arranged along wavy (sinusoidal) lines across or through fabric.

In some aspects, the base layer 506 is any suitable stretchable fabric or stretch material that is stretchable over a threshold. The term “stretch material” as used herein refers to textiles or materials formed using elastomeric yarns. Elastomeric yarns may generally provide a maximum stretch greater than about 200% under load prior to returning to its non-stretched state when the load is removed, and some elastomeric yarns provide a maximum stretch of about 400%. Examples of elastomeric yarn types include SPANDEX®, lycra, rubber, and the like. Moreover, examples of stretch materials or textiles may include stretch woven materials, stretch knit materials, stretch non-woven materials, and the like.

In some aspects, other layers of the wearable article 300 (or any other wearable article described herein), such as the non-conductive layer 504 are non-stretch material. The term “non-stretch material” as used herein refers to textiles or materials that are formed using non-elastomeric yarns that generally do not stretch over a threshold amount (e.g., cotton, silk, polyester, conventional denim, and/or other non-elastic polymers). To describe this differently, non-stretch materials have a lower stretching capacity than stretch materials. A “non-conductive” layer refers to any layer that cannot or is not typically used as a conductor for carrying electrical signals. For example, a non-conductive layer can include glass, rubber, porcelain, ceramic, plastic, or any fabric. This is in contrast to a “conductive” layer, which typically includes metals (e.g., a copper wire) or graphite. A trace, as described herein, is one example of a conductive layer or element.

In some aspects, the base layer 506 is woven via a “DogBone” weave (also known as an I-weave or H-weave). In other words, two or more distinct sets of yarns or threads can interlaced (e.g., at right angles) to form a fabric or cloth, such as the base layer 506. In other aspects, the base layer can include distinct sets of threads or yarns that are knitted, bonded, non-woven, or stitched.

In some aspects, each trace, such as trace 304-1, has a thickness of about 10 micrometer μm (e.g., plus or minus 5% of 10 μm). In some aspects, each trace has a width of a recommended minimum of 2 mm (plus or minus 5% of 2 mm). The length of the trace can be any suitable length that corresponds to the length of the particular wearable article. In various aspects, one or more traces extend, in length, around an entire wearable article in three-dimension such that a three-dimensional model of a body part can be detected, as described in more detail below. For example, in some aspects traces can wrap around an entire width of a metatarsal region corresponding to the bottom of the foot, the sides of the foot, and the top of the foot.

In some aspects, a wearable article, such as the sock structure 300 is designed and manufactured in various layers. For example, in some aspects, the first layer or bottom-most layer is the base layer 506. The second layer on top of the first layer includes the vertical traces 304-1 through 304-4. The third layer on top of the second layer includes the non-conductive layer 504. And the fourth layer on top of the third layer includes the horizontal traces 304-5 through 304-8. Examples of the manufacture of wearable articles are described in more detail below. In some aspects, the non-conductive layer 504 is the same as or represents the fabric outer layer 302 of FIG. 1 or 402 of FIG. 4 such that it is the outer-most or visible to a wearer. In other aspects, there is another “outer layer” of fifth layer disposed over the fourth layer of the horizontal traces 304-5 through 304-8, which represents the outer-most or visible layer to a wearer.

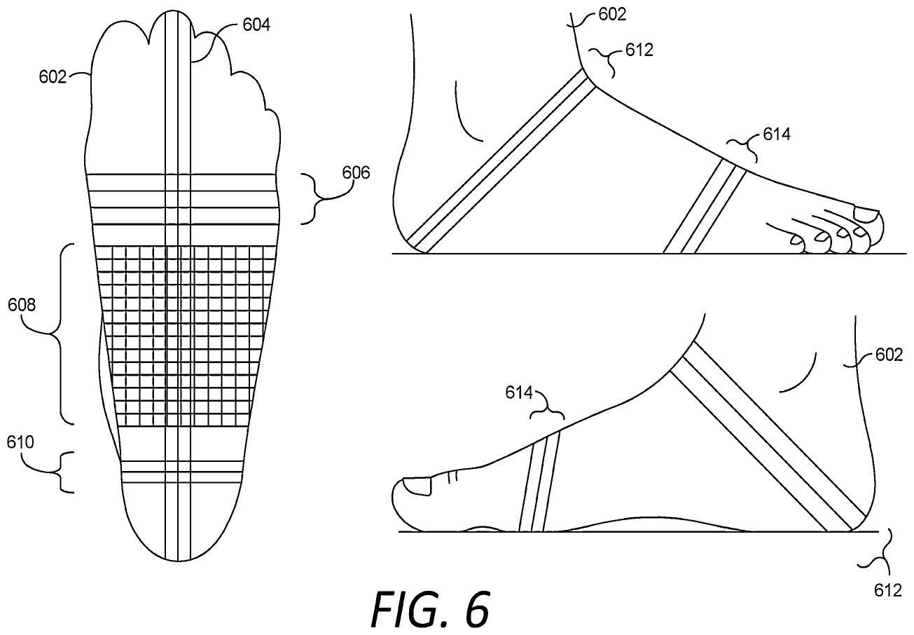

FIG. 6 illustrates where sets of traces are located in correspondence with a human foot 602, according to some aspects. The traces are joined (e.g., weaved into) a wearable article but are illustrated in FIG. 6 so as to show traces in relation to the human foot 602. Accordingly, in various aspects the traces are positioned as illustrated in FIG. 6, except they are incorporated into a wearable article, such as the sock structure 300 of FIG. 3. To identify foot-relate measurements, such as dimensions or any other suitable real-time characteristics of the foot, various aspects use 6 landmark patterns of sets of traces-604, 606, 608, 610, 612, and 614. This allows various aspects to reconstruct a three-dimensional model of the foot 602 with associated measurements, as described in more detail below.

As illustrated by the vertical traces 604, they cover (e.g., are disposed over) the foot 602 (or sock structure) length from the calcaneus region to the phalanges. Any reference to the foot 602 can be replaced by the term “sock structure.” The horizontal traces 606 cover a width of the foot 602 in the distal metatarsal region. The grid pattern traces 608 cover the width of the foot 602 in the arch or proximal metatarsal and tarsal (cuboid, cuneiforms, navicular) regions. The horizontal traces 610 cover the width of the foot 602 at the heel or calcaneus region. The obliquely oriented traces 612 cover the region spanning from the talus or distal tibia region through the ankle or distal fibula region, all the way over the calcaneus region of the foot 602. The horizontal traces 614 cover the distal metatarsal region or metatarsal phalangeal joint region, such as the metatarsal fibulare and metatarsal tibiale regions of the foot 602.

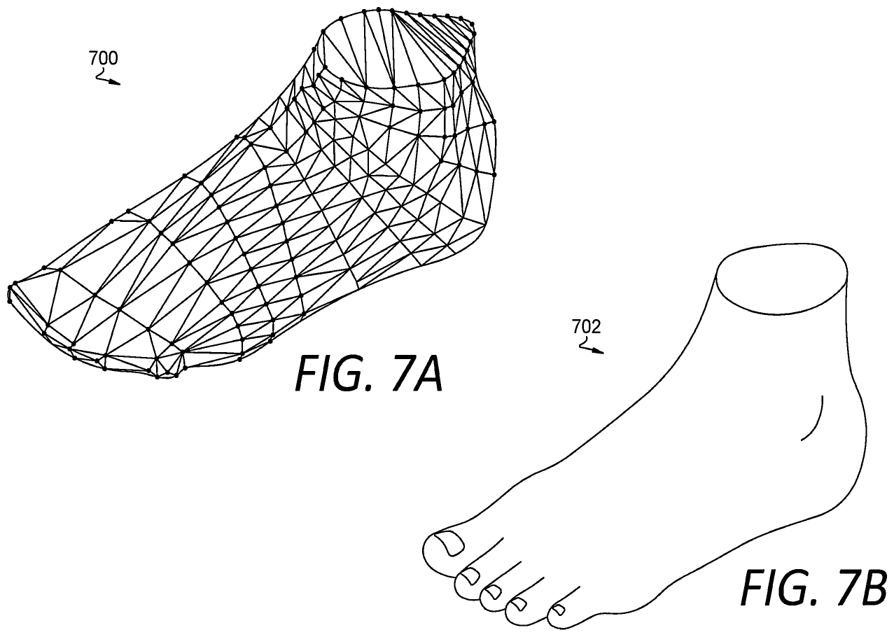

FIG. 7A is illustrates a map 700 of measurement or sensor data provided by each trace of a sock structure, according to some aspects. In various aspects, in order to derive sensor data, a calibration of the stretch sensors is first performed. To do this, some aspects utilize a last (a solid form around which a shoe is molded). For step 1, a sock structure (e.g., 300) is placed on the last that is just large enough to fill out the sock structure with minimal or no stretching to act as a baseline. The impedance values R1 from each of the sensing traces is measured and stored while they are over the last. The second step is measuring stretch while the sock structure is being worn by a human wearer. In various aspects, stretch sensors have varying impedance (or resistance) as they are stretched or otherwise subject to physical stimuli. The more they are stretched, the higher the impedance. The wearer will then put on the sock structure. The processor then applies an electrical signal at a source voltage V1 to each trace in parallel at a first end and then each trace outputs the voltage V2 at a second end, which can be interpreted or measured by the processor. Various aspects use a multiplexer (or “MUX”) to reduce the pin-count needed to measure the impedance of all the traces, as described in more detail below. Various aspects can then determine the resistance of each trace using Ohm's law:

(V1−V2)=IR

Where I=current and R=resistance. V1, V2, and I are known, so aspects can derive R for each trace (“R2”).

In some aspects, the processor applies the V1 electrical signal and the trace outputs its V2 voltage in a continuous loop so as to, for example, provide near-real time data (e.g., probability of shoe fit or comfort) based on dynamic movements of a wearer, as described in more detail below. In some aspects, the R1 readings from the last represent the sock structure in a near real-time initial position based on wearer movement. For example, instead of getting a baseline from a last, particular aspects get a baseline from the wearer's first initial position (or last-in-time position). In these aspects, the R1 values just represent resistance values from a trace that correspond to the sock structure's previous position based on a wearer's real-time movement.

FIG. 7B illustrates a three-dimensional model 702 of a human foot based on the map 700 of sensor data of FIG. 7A, according to aspects. Particular aspects take the sensor data described above with respect to FIG. 7A as input in order to generate a three-dimensional model 702 of the foot. In order to do this, the next step is forming a contour in some aspects. Because R1 is known from the last, and R2 from the user's foot, particular aspects find the change in resistance:

ΔR=R2−R1

Because the stretch-to-impedance characteristics of the material are now known, particular aspects are able to generate a distance measurement from AR. Various aspects then combine all of this information into a data structure matrix, which then causes a contour model of the foot (i.e., the three-dimensional model 702) to be generated. In other words, in order to generate the three-dimensional model 702, particular aspects take, as input, the physical stimuli changes of each trace (e.g., stress, strain, deformation) and the corresponding electrical signal changes (e.g., resistance, capacitance, etc.) as a ratio to generate a distance measurement. For instance, particular aspects take the stretch-to-impedance characteristics of each trace to create a distance measurement from the change in resistance (e.g., from V1 to V2). Particular aspects, combine this data into a data structure, such as a matrix to generate a three-dimensional model 702 of the foot at the latest in time position. In various aspects, such three-dimensional model 702 represents a single instance or frame of a contiguous video of frames such that multiple frames can be stitched together to form a video sequence. For example, in some aspects, a model is generated, which reflects R1 and then the model 702 is generated, which represents R2, which can then be stitched together to generate a near real-time model of a foot for different sequences of time during a time period.

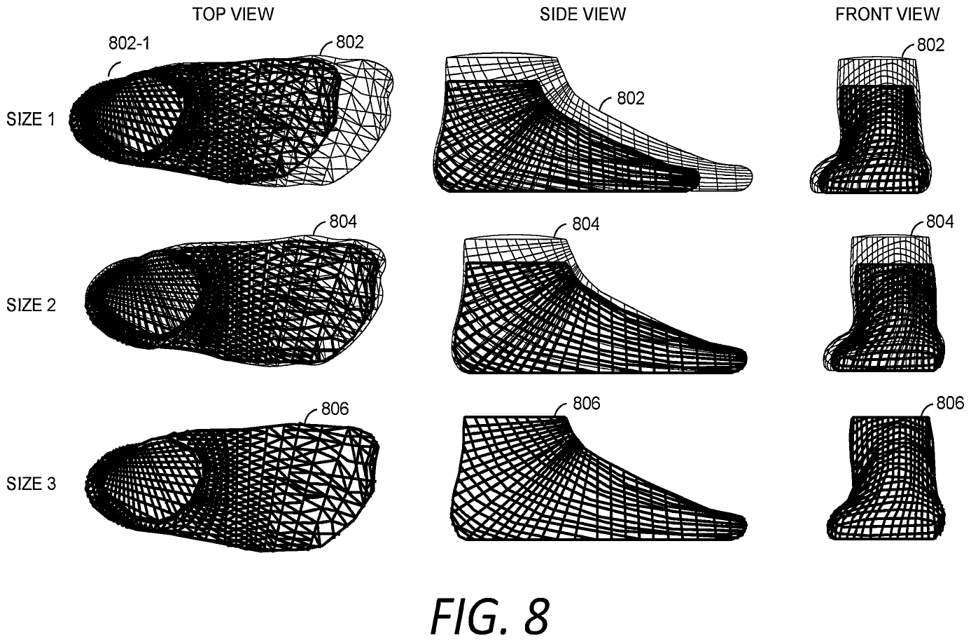

FIG. 8 illustrates different sizes and patterns of a sock structure from different views, according to some aspects. FIG. 8 further illustrates that the stretch sensors can encompass an entire volume of space (representing a slot that a foot goes into) in a three-dimensional manner. Specifically, for instance, the sock structure 802 and corresponding traces encompass the slot 802-1 such that the traces and sock structure 802 can envelop each portion of a corresponding foot, as illustrated by the top view, side view, and front view of the sock structure 802. FIG. 8 also illustrates a sock structure 804 at size 2 at a top view, a side view, and a front view. FIG. 8 also illustrates a sock structure 806 at size 3 at a top view, a side view, and a front view.

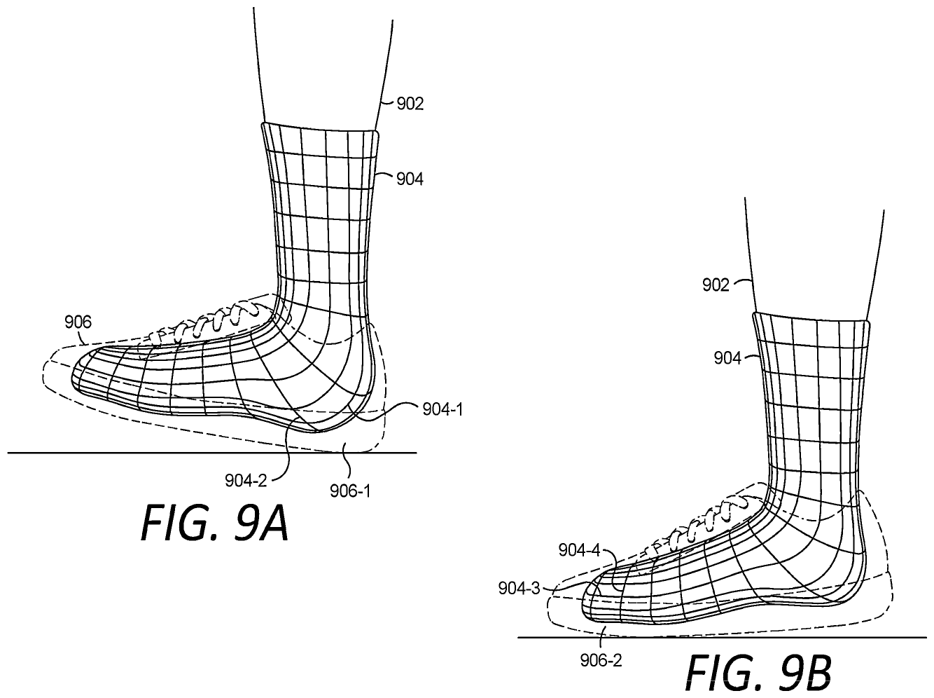

FIG. 9A illustrates a sock structure 904 in relation to a shoe 906 at heel strike and corresponding capacitive sensor values, according to some aspects. In some aspects, the sock structure 904 represents the sock structure 300 of FIG. 1, the sock structure 107 of FIG. 1A, and/or the sock structure 207 of FIG. 2. As described herein, in some aspects, one or more stretch sensors in the sock structure 904 includes one or more capacitive sensors. Each capacitive sensor embedded into the sock structure 904 detects one or more portions of the interior of shoe 906 without physical contact with such interior of the shoe 906. To detect the one or more portions of the interior of the shoe 906, capacitive sensors emit an electrical field from a sensing end (e.g., dielectric plates) of the sensor. Any portion of the interior of the shoe 906 that disrupts this electrical field is detected by the capacitive sensor. Put another way, when a portion of the shoe 906, such as an interior heel portion, comes within a threshold distance of the sensing end or otherwise interrupts the electrical field, this changes the capacitance of an oscillator of the sensor by entering into the electrical field of the sensing end.

In an illustrative example, a trace can be an elongated structure (e.g., a conductive thread) and include a core and an electrode over the core, so as to cover the entire length of the trace. Such electrode can correspond to the sensing end of a capacitive sensor. Accordingly, for example, when the traces 904-1 and 904-2 of the sock structure 904 emit an electric field (e.g., in an X-direction in response to transmitting an electric signal through these traces in a Y-direction), both traces detect the portion 906-1 (e.g., corresponding to an upper surface of a heel region) of the interior of the shoe 906. However, both traces 904-1 and 904-2 and various other traces can likewise detect interior portions of the shoe 906 along their entire length.

In some aspects, a capacitor sensor measures changes in capacitance and translates these changes to distance or position measurements to generate models of a foot and/or shoe. For example, the trace 904-1 can detect a distance or position from its sensing end (e.g., its electrode) to the upper surface of the interior portion 906-1 of the shoe 906 by translating its electrical field disruption characteristics into distance or position. In these aspects, the position or distance of an object is from a trace, such as the portion 906-1, is directly proportional to the quantity of change in the capacitor sensor's electric field.

Capacitive sensors measure capacitance changes of the sensing devices induced by external mechanical stimuli. In some aspects, capacitance of a sensing device is defined as C=εrεoA/d, where Fr is the relative permittivity, εo is the vacuum permittivity, A is the effective area of the electrode (e.g., an outer conductor that an electric current exits or leaves), and d is the pole-plate spacing. Therefore, changes of one or more parameters of the permittivity, spacing, or effective area causes a change in capacitance of the traces, and then the magnitude of the mechanical stimulus that causes the parameter change can be quantified. In some aspects, capacitive sensors include two electrode layers and a dielectric layer, where the electrodes require suitable electrical conductivity. In some aspects, the electrode can be made of materials, such as conductive fabrics, metal wires, carbon materials, etc. Although each electrode is typically conductive, the capacitive response is irrelevant to the change in resistance of the electrode during exposure to mechanical stimulation. At the same time, the materials used as dielectric layers usually possess a large dielectric constant to reduce leakage current. Commonly used dielectric materials are elastic polymers, fabric gaskets, ionic gels, etc. Some aspects use silver-plated compound silk fibers as electrodes and high-permittivity ion gel membranes as the dielectric material. In some aspects, the composition and membrane thickness of the ionic gel are designed to maximize the change of the contact area between the electrodes and the ionic gel under external forces, which in turn optimized the sensing performance of the capacitor sensors.

Continuing with FIG. 9A, at a first time, the lower limb 902 of the wearer is in a particular gait phase, such as heel-strike. Accordingly, such heel-strike causes particular physical stimuli (e.g., stress, strain, or deformation) to be experienced by the traces of the sock structure 904. For example at a time corresponding to FIG. 9A, the electrical fields emitted by a first end of the trace 904-1 and 904-2 (near a heel portion) may indicate that the portion 906-1 of the shoe 906 is abutting the traces at the first end or a particular close distance from the traces 904-1 and 904-2. And the electrical fields emitted by other traces, such as near a toe region of the traces, may indicate that corresponding toe portion of the shoe 906 is further in distance away from the toe traces relative to the first end of the traces 904-1 and 904-2 touching the portion 906-1. Accordingly, a model or map can be generated, similar to FIG. 9A, which indicates the position of each portion of the sock structure 904 in relation to each corresponding portion of an interior portion of the shoe 904. Specifically, the model or map can illustrate that portion 906-1 of the interior portion of the shoe 906 is abutting or near corresponding regions of the traces 904-1 and 904-2 and that other interior portions of the shoe 906 near a toe regions is relatively further away from corresponding traces near the toe region. By detecting changes in capacitance, the capacitance sensors can detect both the pressure exhibited on a corresponding trace section and the position portions of the shoe 906 in relation to corresponding traces.

In some aspects, additional or alternative stretch sensors can be used to generate a map identical to FIG. 9A and make various determinations (e.g., shoe fit). For example, some sensors can include resistance sensors, piezoresistive sensors, or the like. These sensors directly convert mechanical stimuli (e.g., stress, strain, deformation, or pressure) experiences by the traces into corresponding electrical signal sensor values. In other words, the experienced mechanical stimuli is directly proportional to the electrical signal sensor values.

In some aspects, resistive sensors convert mechanical stimuli, such as displacement or force, to a resistance change, using piezoresistive materials. As the resistance of a conductive material is defined as R=ρL/S, when a mechanical stimulus causes changes of the piezoresistive materials in resistivity (ρ), length (L), and/or cross-sectional area (S), it will bring out a resistance change. The sensing response of resistive sensors depends on the interaction of: (1) intrinsic changes in the resistance of sensing elements in response to mechanical stimuli; (2) geometric variation of a wearable article; and (3) changes in the set of traces (e.g., a grid structure). Based on a regression curve, the mechanical stimuli and their degrees can be determined.

In some aspects, resistive sensors include a soft substrate and a sensing material. In some aspects, soft substrates have properties such as a certain elasticity, good flexibility, and long-term stability. These properties can provide an electric signal carrier for sensing materials, and provide the sensing materials and subsequent textiles with piezoresistive properties. They can also reduce the stress concentration of sensors when subjected to mechanical stimuli. Example substrates can include silk, cotton, polydimethylsiloxane (PDMS), polyurethane (PU), etc. In some aspects, sensing elements have carbon materials, metal materials, conductive polymers, etc. In some aspects, the sensing ends are prepared by coating, depositing, winding, or electroplating functional conductive layer on fibers, yarns, or fabrics, and they can also be prepared by wet spinning or 3D printing processes. In some aspects, a resistive trace includes a fibrous core electrode wrapped and wound by piezoresistive elastic nanofibers. The yarn can be woven into fabrics (e.g., the base layer 506 or the non-conductive layer 504 to achieve multi-mode sensing of various mechanical stimuli. Resistive traces can also be designed and prepared by the methods of coating, deposition, inkjet printing, screen printing, etc. Among them, directly coating sensing ends onto common fabrics is the simplest and easiest method to achieve large-scale.

In some aspects, piezoelectric sensors are produced from flexible materials with piezoelectric effects, which work by converting mechanical stimuli into voltage signals. The piezoelectric constant of the piezoelectric material determines the performance of a piezoelectric sensor in converting mechanical energy into electrical energy. In some aspects, piezoelectric materials include composites, polymers, ceramics, single crystals, and the like.

Piezoelectric traces can generate internal voltage when subjected to external pressure, which makes them self-powered while achieving pressure sensing. In addition, such sensors often present the advantages of fast response time and high sensitivity, giving them great utility in wearable articles. In some aspects, piezoelectric traces are constructed with three layers that include polyvinylidene fluoride (PVDF) membrane, the top and bottom electrode layers of conductive rGO-PET fabrics with self-orientation ZnO nanorods. When subjected to an external force, the piezoelectric configuration (e.g., a grid structure) deforms, leading to a potential difference between the two electrode layers so the magnitude of external force can be obtained by detecting the voltage change.

FIG. 9B illustrates the sock structure 904 of FIG. 9A in relation to the shoe 906 at heel-off and corresponding capacitive sensor values, according to some aspects. At a second time subsequent to the first time corresponding to FIG. 9A, the lower limb 902 of the wearer is in a particular gait phase—a “heel-off” phase, meaning that the heel is now off (as opposed to being in heel-strike at FIG. 9A). Accordingly, such heel-off causes particular physical stimuli (e.g., stress, strain, or deformation) to be experienced by the traces of the sock structure 904. For example at a time corresponding to FIG. 9B, the electrical fields emitted by a first end of the trace 904-1 and 904-2 (near a heel portion) may indicate that the portion 906-1 of the shoe 906 is an inch away from the traces at the first end of the traces 904-1 and 904-2. And the electrical fields emitted by other traces, such as near a toe region of the traces, may indicate that corresponding toe portion of the shoe 906 is closer to or abutting the toe traces relative to the first end of the traces 904-1 and 904-2 touching the portion 906-1. Accordingly, a model or map can be generated, similar to FIG. 9B, which indicates the position of each portion of the sock structure 904 in relation to each corresponding portion of an interior portion of the shoe 906. By detecting changes in capacitance, the capacitance sensors can detect both the pressure exhibited on a corresponding trace section and the position portions of the shoe 706 in relation to corresponding traces.

In response to generating such maps or models, similar to FIG. 9A and FIG. 9B, some aspects then make various determinations, such as fit of the shoe 906, comfort of the shoe 906, or the like. In such aspects, particular aspects, for example, can provide, as input, the map of FIG. 9A and FIG. 9B (or corresponding data points, such as capacitance readings at each trace at each time period), to a machine learning model. Additionally or alternatively, some aspects map, via a data structure, each reading of each trace to a particular state or characteristic. For example, a particular capacitance range can be mapped to a particular “fit” category (e.g., does not fit) in a lookup data structure. In these aspects, each sensor data reading has a predetermined state or category that is programmed to a lookup or other data structure. For instance, resistance value A is mapped to fit suitability B, or comfort level C via using a key (i.e., the sensor value reading) of the lookup data structure to its corresponding value—its particular state, such as fit or comfort.

In some aspects, the wearable footwear need not be a shoe 906 as illustrated in FIGS. 9A and 9B. Rather, in some aspects, the shoe 906 can instead be any suitable object near or in association with a wearable article. For example, in some aspects, 906 represents a helmet and the sock structure 904 represents the wearable article 404 of FIG. 4. In this way, for example, portions of the helmet can be detected via a capacitor sensor's transmission of an electric field and corresponding interference from an interior portion of a helmet, as described above to determine attributes, such as helmet fit suitability. In some aspects, the interior of the shoe 906 additionally or alternatively includes sensors that are fastened thereto, such as capacitor sensors, range finders, small cameras, lidar, or the like to more robustly generate a map of the interior portion of the shoe 906 in order to determine shoe fit, comfort, or the like.

### Example Model

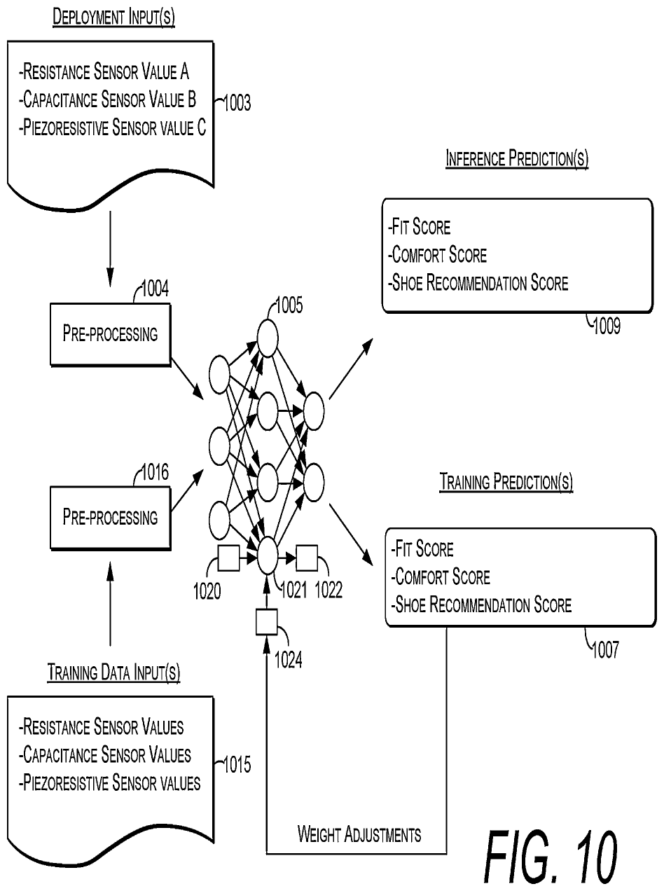

FIG. 10 is a schematic diagram illustrating how a neural network 1005 generates scores indicative of fit, comfort, and shoe recommendations, according to some aspects. In some aspects the neural network 1005 represents or includes any suitable model functionality, such as supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial lest squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or any suitable form of machine learning algorithm.

The neural network 1005 is modeled as a data flow graph (DFG), where each node (e.g., 1021) in the DFG is an operator with one or more input and output tensors, such as 1020 and 1022. A “tensor” (e.g., a vector) is a data structure that contains values representing the input, output, and/or transformations processed by the operator. Each edge of the DFG depicts the dependency between the operators. Neural network 1005 includes an input layer, an output layer and one or more hidden layers. An Input layer is the first layer of the neural network 1005. The input layer receives pre-processed (e.g., via the pre-processing 1004 or 1016) input data represented by 1003 and 1015, such as one or more resistance values (derived from a resistive trace), one or more capacitance sensor values (derived from a capacitor sensor), and/or one or more piezoreistance values. The Output layer is the last layer of neural network 1005. The output layer generates one or more inferences in the form of clustering, regression, classifications, or the like, which can either be hard classification (e.g., the shoe “fits”) or soft probabilities (e.g., 50% likely that the shoe fits), which is represented by the predictions 1009 and 1007. Neural network 1005 may include any number of hidden layers. Hidden layers are intermediate layers in neural network 1005 that perform various operations.

Each node in FIG. 10, such as node 1021, is associated with or includes one or more activation tensors, such as input tensor 1020, output tensor 1022, and/or intermediate tensors. An “activation tensor” is a tensor that is an input, intermediate, and/or output to at least one neural network layer (e.g., as modeled going from left to right), as illustrated by the flow of data from input tensor 1020 to output tensor 1022. This is different than a weight tensor, such as 1024, where weight tensors are modeled as flowing upward (not being actual inputs or outputs). In other words activation tensors represent some form of the neural network inputs 1003 and 1015. For example, the input tensor 1020 or node 1021 can represent whether particular sensor data values inside or outside of a threshold were present for a particular set of traces (e.g., the set of traces 612 of FIG. 6) (or in a particular area of a set of traces) and/or corresponding wearable article, whereas a weight tensor represents the weight values indicating node activation/inhibition values.

Each node in the network 1005 may also be associated with or include and/or one or more weight tensors (e.g., 1024), which include weight values. A “weight” in the context of machine learning may represent the importance or significance of a feature or feature value for prediction. For example, each feature (e.g., resistance values within a range at a particular foot location) may be associated with an integer or other real number where the higher the real number, the more significant the feature is for its prediction. In one or more aspects, a weight in a neural network represents the strength of a connection between nodes or neurons from one layer (an input) to the next layer (a hidden or output layer). A weight of 0 may mean that the input (e.g., the input tensor 1020) will not change the output (e.g., the output tensor 1022), whereas a weight higher than 0 changes the output. The higher the value of the input or the closer the value is to 1, the more the output will change or increase. Likewise, there can be negative weights. Negative weights may proportionately reduce the value of the output. For instance, the more the value of the input increases, the more the value of the output decreases. Negative weights may contribute to negative scores. For example, comfort may be highly correlated with the amount of pressure on a lateral metatarsal portion of a foot and so neural network layers or nodes representing the lateral metatarsal portion and corresponding sensors may be weighted higher so that that this data is activated or taken into account when making a final prediction score.

Each node of the neural network 1005 may additionally perform one or more functions using the activation tensors and weight tensors, such as activation functions, matrix multiplication, normalization, or the like. In some aspects, the nodes in the neural network 1005 are fully connected or partially connected. Continuing with FIG. 10, each node may process one or more inputs in 1003 and 1015 (or portion thereof) using activation tensors and weight tensors. In some aspects, in response to receiving the deployment input(s) 1003 and the training data input(s) 1015, the neural network 1005 first performs pre-processing 1004 or 1016, such as encoding or converting such input into machine-readable indicia representing the entire input (e.g., a tensor representing sensor values over a particular time span). Responsively, the node may then receive an input tensor, which may, for example, represent whether one or more features (e.g., particular sensor value ranges in particular locations of traces (e.g., traces 608) or wearable articles) are present in the input. In some aspects, the input tensor is an N-dimensional tensor, where N can be greater than or equal to one. In some aspects, an input tensor 1020 represents the input data of neural network 1005 if the node is in the input layer. In some aspects, the input tensor 1020 is also the output of another node in the preceding layer. In some aspects after a node, such as the node 1021, performs an operation using the input tensor 1020, it generates an output tensor 1022, which is then passed to the other neurons in the hidden layer and/or output layer. The output tensor 1022 represents the output processed by the node 1021. For example, the output tensor 1022 may be a matrix representing the product of matrix multiplication or a matrix indicating whether the sensor values have exceeded a threshold (or are within a range) at a particular location within a set of traces or wearable article. In various aspects, the output tensor 1022 represents an input of another node in the succeeding layer (i.e., the output layer).

In some aspects, node 1021 applies a weight tensor 1024 to the input tensor 820 via a linear operation (e.g., matrix multiplication, addition, scaling, biasing, or convolution). All other nodes in the neural network may perform identical functionality. In some aspects, the result of the linear operation is processed by a non-linear activation, such as a step function, a sigmoid function, a hyperbolic tangent function (tan h), and rectified linear unit functions (ReLU) or the like. The result of the activation or other operation is an output tensor 1022 that is sent to a subsequent connected node that is in the next layer of neural network 1005. The subsequent node uses the output tensor 1022 as the input activation tensor to another node.

Each of the functions in the neural network 1005 may be associated with different coefficients (e.g., weights and kernel coefficients) that are adjustable during training. For example, after preprocessing 1016 (e.g., normalization, feature scaling and extraction) in various aspects, the neural network 1005 is trained using one or more data sets of the preprocessed training data inputs 1015 in order to make acceptable loss training predictions at the appropriate weights to set the weight tensors. This will help later at deployment time to make correct inference predictions 1009. In one or more aspects, learning or training includes minimizing a loss function between the target variable (for example, an incorrect prediction score indicating that the shoe fits) and the actual predicted variable (for example, a correct prediction score that the shoe does not fit). Based on the loss determined by a loss function (for example, Mean Squared Error Loss (MSEL), cross-entropy loss, etc.), the loss function learns to reduce the error in prediction over multiple epochs or training sessions so that the neural network 1005 learns which features and weights are indicative of the correct inferences, given the inputs. Accordingly, it is desirable to arrive as close to 100% confidence in a particular classification or inference as much as possible so as to reduce the prediction error. In an illustrative example, the neural network 1005 learns that for a given set of resistance values A, capacitance sensor values B, and piezoreistance values C at location Z (e.g., within the set of traces or wearable article), the correct classification is that the shoe does not fit.

Subsequent to a first round/epoch of training, the neural network 1005 makes predictions with a particular weight value, which may or may not be at acceptable loss function levels. For example, the neural network 1005 may process the pre-processed training data inputs 1015 a second time to make another pass of predictions. This process may then be repeated over multiple iterations or epochs until the weight values in the weight tensors are learned for optimal or correct predicted values (for example, by maximizing rewards and minimizing losses) and/or the loss function reduces the error in prediction to acceptable levels of confidence.

In some aspects, before the training data input(s) 1015 (or deployment input(s) 1003) are provided as input into the neural network 1005, the inputs are preprocessed at 1016 (or 1004). In some aspects, such pre-processing includes feature scaling, feature extraction, normalization, and the like. Scaling (or “feature scaling”) is the process of changing number values (e.g., via normalization or standardization) so that a model can better process information. For example, some aspects can bind number values between 0 and 1 via normalization. Other examples of preprocessing includes feature extraction, handling missing data, feature scaling, and feature selection.

Feature extraction involves computing a reduced set of values from a high-dimensional signal capable of summarizing most of the information contained in the signal. Feature extraction techniques develop a transformation of the input space onto the low-dimensional subspace that attempts to preserve the most relevant information. In feature selection, input dimensions that contain the most relevant information for solving a particular problem are selected. These methods aim to improve performance, such as estimated accuracy, visualization, and comprehensibility. An advantage of feature selection is that important information related to a single feature is not lost, but if a small set of features is required and original features are very diverse, there is chance of information being lost as some of the features must be omitted. On the other hand, with dimensionality reduction, also known as feature extraction, the size of the feature space can often be decreased without losing information about the original feature space.

In some aspects, the pre-processing of the data at 1016 and/or 1004 includes missing data techniques. In some aspects, these missing data techniques include complete case analysis, single imputation, log-linear models and estimation using the EM algorithm, propensity score matching, and multiple imputations. The technique confines attention to cases for which all variables are observed in a complete case analysis. In a single implicit imputation method, missing values are replaced by values from similar responding units in the sample. The similarity is determined by looking at variables observed for both respondent and non-respondent data. Multiple imputations replace each missing value with a vector of at least two imputed values from at least two draws. These draws typically come from stochastic imputation procedures. In the log linear model, cell counts of a contingency table are modeled directly. An assumption can be that, given expected values for each cell, the cell counts follow independent multivariate Poisson distributions. These are conditional on the total sample size, with the counts following a multinomial distribution.

In some aspects, the preprocessing at 1016 and/or 1004 includes outlier detection and correction techniques for handling outlier data within the input data 1015/1003. Outliers, by virtue of being different from other cases, usually exert a disproportionate influence on substantive conclusions regarding relationships among variables. An outlier can be defined as a data point that deviates markedly from other data points. For example, error outliers are data points that lie at a distance from other data points because they result from inaccuracies. More specifically, error outliers include outlying observations that are caused by not being part of the targeted population of data, lying outside the possible range of values, errors in observation, errors in recording, errors in preparing data, errors in computation, errors in coding, or errors in data manipulation. These error outliers can be handled by adjusting the data points to correct their values or more such data points from the data set. In some implementations, particular aspects define values more than three scaled median absolute deviations (“MAD”) away from the median as outliers. Once defined as an outlier, some aspects replace the values with threshold values used in outlier detection.

In some aspects, the preprocessing at 1016 and/or 1004 includes feature selection at the input data 1015 and/or 1003. Feature selection techniques can be performed for dimensionality reduction from the extracted features. The feature selection techniques can be used to reduce the computational cost of modeling, to achieve a better generalized, high-performance model that is simple and easy to understand. Feature extraction techniques can be performed to reduce the input data's dimensionality. However, in some implementations, the resulting number of features may still be higher than the number of pre-training data 1015. Therefore, further reduction in the dimensionality of the data can be performed using feature selection techniques to identify relevant features for classification and regression. Feature selection techniques can reduce the computational cost of modeling, prevent the generation of a complex and over-fitted model with high generalization error, and generate a high-performance model that is simple and easy to understand. Some aspects use the mRmR sequential feature selection algorithm to perform feature selection. The mRmR method is designed to drop redundant features, which can design a compact and efficient machine learning-based model.

In one or more aspects, the neural network 1005 converts or encodes the deployment input(s) 1003 and training data input(s) 1015 into corresponding feature vectors in feature space (for example, via a convolutional layer(s)). A “feature vector” (also referred to as a “vector”) as described herein may include one or more real numbers, such as a series of floating values or integers (for example, [0, 1, 0, 0]) that represent one or more other real numbers, a natural language (for example, English) word and/or other character sequence (for example, a symbol (for example, @, !, #), a phrase, and/or sentence, etc.). Such natural language words and/or character sequences correspond to the set of features and are encoded or converted into corresponding feature vectors so that computers can process the corresponding extracted features. For example, aspects can parse, tokenize, and encode each value or other content in pages into one or more feature vectors.

Continuing with FIG. 10, in some aspects, the neural network 1005 is trained in a supervised manner using annotations or labels. For example, in some aspects, training includes (or is preceded by) annotating/labeling training data 1015 so that the neural network 1005 learns associations between the features or weights and corresponding labels, which is used to change the weights/neural node connections for future predictions. For example, particular aspects capture or sample sensor data from each trace of a wearable article at a first time and then output that information as a report. Responsively, wearers, subject matter experts, or programming logic then label such report as “comfortable” or “fits,” which indicates whether a shoe or other wearable article fits or is comfortable at a time corresponding to the first time. Such process can repeated for various subsequent times and positions of traces and wearable articles so that labels can be made for different positions of traces and wearable articles in order to, for example, provide near real-time scores indicative of fit, comfort, or shoe recommendations based on a sequence of time a wearer wears a wearable article. In this way, the neural network 1005 can learn which weights or features and their corresponding sensor data values are indicative of fit, comfort, or shoe recommendations, either for the article of apparel as a whole, or different portions of the wearable article. As such, the neural network 1005 accordingly adjusts the weights (the weight tensors) or deactivates nodes such that certain nodes corresponding to certain sensor values at particular locations are activated and other nodes corresponding to other certain sensor values at particular locations are inhibited to make score predictions.

In some aspects, the specific labels represent additional or alternative labels, such as a shoe recommendation label. For example, a report of sensor data can be labeled as “basketball shoe,” “running shoe” or the like, which captures sensor readings and mechanical stimulus characteristics associated with particular types of shoes. In another example, the labels can be a “design X” or “activity P” label, which corresponds to a particular wearable article design recommended for a particular shoe based on the sensor value readings report. For example, a particular wearer may determine that a particular brand and design fits and is comfortable while performing a particular activity. Accordingly, the wearer can label a corresponding report as “brand A, design X” and “basketball,” which indicates that for particular sensor value readings, such design and activity was performed. In this way, the neural network 1005 can learn the weights indicative of the design and/or activity for design and/or recommendations (e.g., the shoe recommendation score or an activity recommendation score) at 1009

In one or more aspects, subsequent to the neural network 1005 training, the neural network 1005 (for example, in a deployed state) receives one or more of the pre-processed deployment input(s) 1003. When a machine learning model is deployed, it has typically been trained, tested, and packaged so that it can process data it has never processed. Responsively, in one or more aspects, the deployment input(s) 1003 (i.e., the resistance sensor value A at location Z (in a set of traces), the capacitance sensor value B at location Z, and the piezoresistive sensor values C at location Z) are fed to the neural network 1005, which then uses the same weight tensors (e.g., 1024) that were learned via training so that the neural network 1005 can produce the correct inference predictions 1009. For example, the input tensor 1020 can include new values (e.g., sensor readings indicated in 1003), which is then multiplied or otherwise combined with the weight tensor 1024, representing the same weight values learned at training, in order to make the inference prediction(s) 1009.

Regarding the interference predictions 1009 and the training predictions 1007, these correspond to a fit score, a comfort score, or a shoe recommendation score. A “score” as described herein refers to a particular distance (e.g., Euclidian, Cosine), confidence level interval (e.g., 0.95), and/or cluster, regression, or classification indication. For example, a “fit score” may be a score, such as a 0.95 confidence that a particular foot is classified as “fits,” or “does not fit.” In another example with respect to distance, the deployment input(s) 1003 can be combined to form a data point, such as a first vector in vector space. Various aspects can then compare or determine a distance from the first vector to other vectors each representing training data points and other predictions scores (e.g., a clustering group). Accordingly, for example, aspects can determine that the first vector is closest to a first classification group-“shoe fits”-relative to its distance to a second clustering classification group-“shoe does not fit.” Accordingly, particular aspects can responsively, generate a score or other indicia at 1009 indicating that the shoe fits.

A “comfort score” may include a particular confidence level interval indicative of a regression score or classification that the shot is “comfortable,” “not comfortable,” or “somewhat comfortable.” In some aspects, the shoe recommendation score may be indicative of various categories of shoes or shoe design recommended for a wearer. For example, based on the sensor value readings at the deployment input(s) 1003, the neural network 1005 generates a score that indicates that a shoe should have extra padding at the heel portion due to excessive forces at heel strike. In another example, if a wearer performs different activities in the same shoe (e.g., running versus playing basketball), particular aspects can recommend better fitting shoes. A corresponding app, for example, could tell a wearer that the shoe recommended is for running but not basketball based on real-time 3D heat map data. In some of these embodiments, there are additional or alternative scores, such as an activity recommendation score. An activity recommendation score may include a particular confidence level interval indicative of a regression score or classification of the most suitable activity (e.g., basketball, football, tennis, etc.) that a wearer should engage in given the sensor data,

### Example User Interface

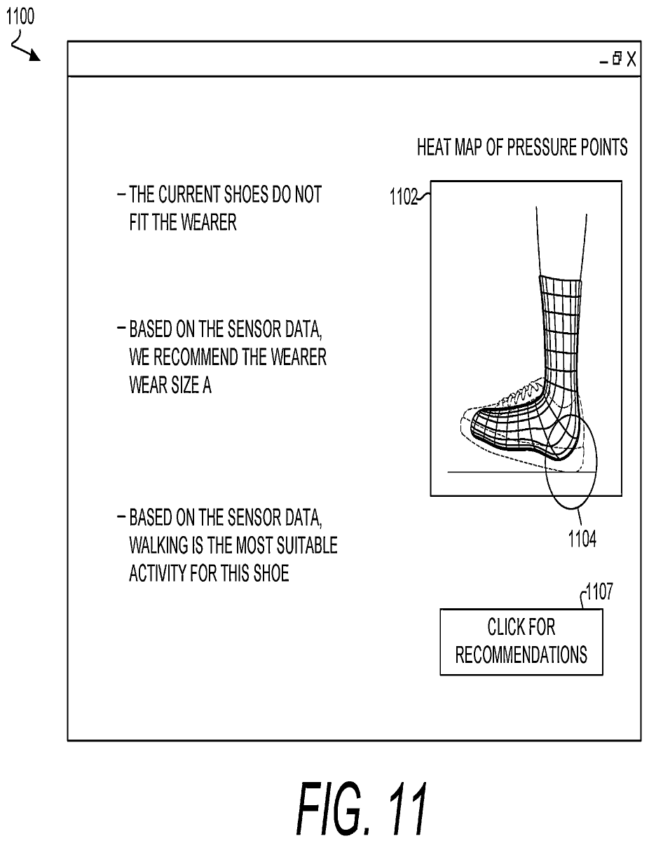

FIG. 11 is a screenshot 1100 of an example user interface, according to some aspects. In some aspects, the screenshot 1100 is a result of the neural network 1005 performing its functionality based on measured sensor readings from wearable articles, such as 300 of FIG. 3. The screenshot 1100 includes a heat map 1102 of pressure points of a three-dimensional foot. The “hot-spot” 1104 indicates (e.g., via red color pixel values) portions of the traces (e.g., traces 614 of FIG. 4, corresponding wearable article and/or foot) that have exceeded a sensor data threshold corresponding to pressure. For example, the hot spot 1104 may indicate that corresponding portions of traces, portions of the wearable article, or portions of a foot have exceeded a resistance or pressure threshold. In some aspects, other portions of the heat map 1102 indicate (e.g., via cooler pixel values, such as blue) that other corresponding portions of the traces, wearable article, and/or foot are associated with sensor data that have not exceeded the sensor data threshold. This may be represented, for example, in the heat map 1102 by all the non-circle elements or portions of the wearable article that are not included in the hot spot 1104.

FIG. 11 also illustrates recommendations that can be made when the sensor data threshold exceeds and/or does not exceed the threshold at one or more portions of the traces, wearable article, and/or foot. For example, as illustrated at the screenshot 1100, in response to receiving an indication that the button 1107 has been selected, different natural language recommendations can be presented. For example, indicia, such as “the current shoes do not fit the wearer” can be presented (e.g., based on the neural network 1005 performing its functionality). Alternatively or additionally, other indicia can be presented, such as “based on the sensor data, we recommend the wearer wear size A.” In some of these aspects, computing logic can, for example, generate and use data structures, such as lookup tables, to map the users shoe size information derived from the sensor data to the size of shoe for a recommendation. For instance, each row or key of the data structure can correspond to a sensor data value range (e.g., resistance values A to resistance values C) and/or a corresponding location in a wearable article or foot. And the value for each corresponding key can be the recommended shoe size.

As further illustrated at the screenshot 1100, some aspects provide user interface elements of “running is the most suitable activity of this shoe” (e.g., based on determining an activity recommendation score, as described herein). In some of these aspects, for example, a wearer can perform different activities (e.g., running, football, basketball, tennis) in the same shoe. Responsively, traces within the wearable article of the shoe can convert physical stimuli (e.g., deformation) during such different activities into electrical signals to determine if any of the signals exceed a threshold, which can be set by programmers (or fed into a model, such as the neural network 1005) based on the activity performed. For example, with respect to sprinting, since the runner may be expected to apply force to a metatarsal and toe region of the foot and less on the heel or calcaneus portion, force thresholds can be set accordingly for determining activity recommendation scores. But such force distribution may be different than, for example, walking activities where a wearer may be expected to place more force on the heel portion, such as during heel-strike. Accordingly, each threshold (e.g., expected range of sensor data readings) may be set via programming logic or a machine learning model based on the specific activity. Accordingly, if any sensor readings fall outside of or exceed such threshold, for example, a different activity can be recommended based on the particular activity recommendation score where the thresholds more closely match the wearer sensor data readings. Subsequently, for example, a corresponding computer application page or web page (e.g., the screenshot 1100) can recommend to the wearer that the shoe is recommend for activity A but not activity B based on real-time sensor data or 3D heat map data, such as the data indicated in the heat map 1102.

### Example Methods

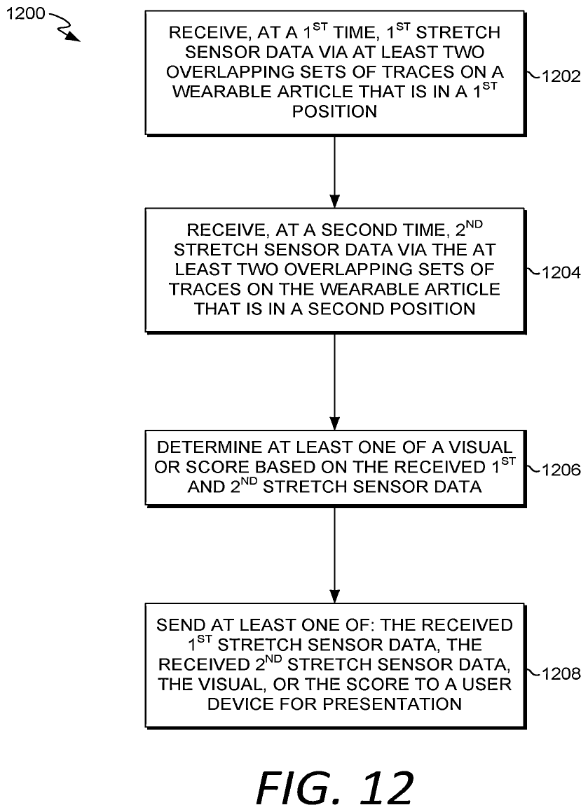

FIG. 12 is a flow diagram of an example process 1200 for determining and sending stretch sensor data, a visual, and/or a score, according to some aspects. The process 1200 (and/or any of the functionality described herein) may be performed by processing logic that comprises hardware (e.g., circuitry, hardware accelerator (e.g., AI accelerator), dedicated logic, programmable logic, microcode, etc.), software (e.g., instructions run on a processor to perform hardware simulation), firmware, or a combination thereof. Although particular blocks described in this disclosure are referenced in a particular order at a particular quantity, it is understood that any block may occur substantially parallel with or before or after any other block. Further, more (or fewer) blocks may exist than illustrated. Added blocks may include blocks that embody any functionality described herein (e.g., as described with respect to FIG. 1 through FIG. 23). The computer-implemented method, the system (that includes the wearable article and a processor), and/or a computer readable medium in association with a processor as described herein may perform or be caused to perform the process 1200 or any other functionality described herein.

Per block 1202, some embodiments receive, at a first time, first stretch sensor data via at least two overlapping sets of traces on a wearable article that is in a first position. For example, referring back to FIG. 5, particular embodiments receive first stretch sensor data (e.g., resistance values) from the traces 304-1 through 304-8, where traces 304-1 through 304-4 and 304-5 through 304-8 overlap with each other. The first position can be any suitable position (e.g., heel-strike). In some aspects, the traces 304-1 through 304-8 (or a processor within the wearable article) generates the first sensor data and then the wearable article transmits (e.g., via network interface card), over a network, the first sensor data such that a network device receives such data and performs block 1202 (and the rest of the process 1200).

Per block 1204, some embodiments receive, at a second time, second stretch sensor data via the at least two overlapping sets of traces on the wearable article that is in a second position. For example, using the illustration above, when the wearable article 300 is in a second position (e.g., heel-off), the same stretch sensors 304-1 through 304-8 generate additional stretch sensor data and send it over a network for further processing.

Per block 1206, some embodiments determine at least one of a visual or score based at least in part on the received first and second stretch sensor data. A “visual” as described herein refers to any data representing a display element, such as one or more letters, symbols, words, images, or the like. For example, a visual can include any portion of the shoe recommendation 111 of FIG. 1B, any indicia (e.g., the fit score) in 211 of FIG. 2, the model of the foot 702 in FIG. 7B, or any portion of the screenshot 1100 of FIG. 11, data points, or the like. A “score” as described herein refers to a particular distance (e.g., Euclidian, Cosine), confidence level interval (e.g., 0.95), and/or cluster, regression, or classification decision statistic. For example, a “fit score” may be a score, such as a 0.95 confidence that a particular foot is classified as “fits,” or “does not fit.” In another example with respect to distance, the deployment input(s) 1003 can be combined to form a data point, such as a first vector in vector space. Such score can include any of the scores described herein, such as the “fit score,” “comfort score,” or the “shoe recommendation score” as described in the inference prediction(s) 1009 of FIG. 10.

Such score and visual can be determined via any method described herein. For example, a score can be determined via the neural network 1005 of FIG. 10 or any programmed data structure that maps particular stretch sensor data (or ranges) to corresponding scores. For example, a lookup data structure may include a range of resistance values A through C as a key in a record, where the same record includes values of a specific fit score of D for the particular range of resistance values. Regarding determining visual, particular embodiments use any suitable method, such as using a matrix (e.g., the data that represents the visual) of stretch sensor data to generate the model 702, as described with respect to FIG. 7B. In some aspects, determining a visual includes determining where the “hot spots” (e.g., 1104 of FIG. 11) will be based on which sensor data exceeds a threshold, as described herein. In some embodiments, determining a visual includes the functionality as described with respect to FIGS. 9A and 9B.

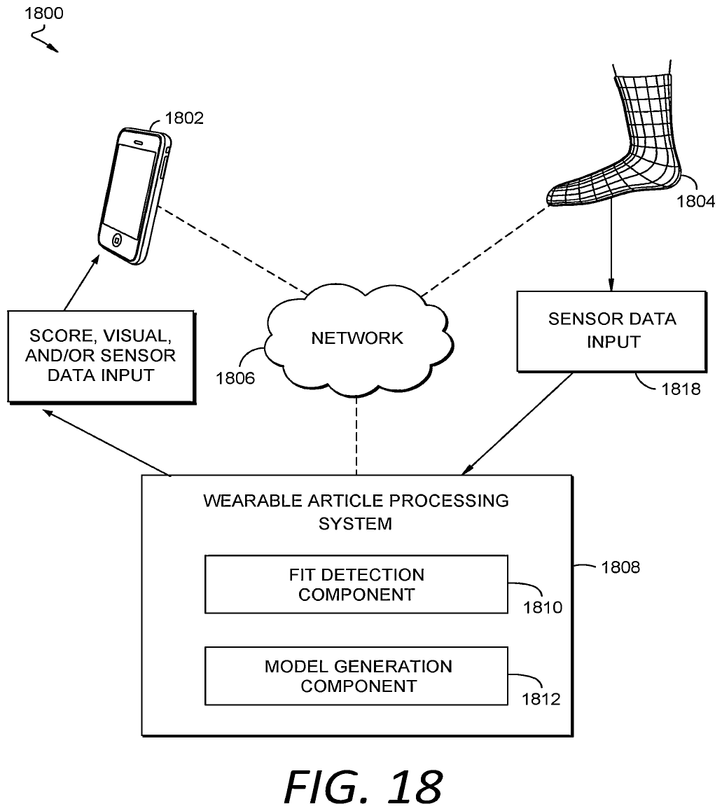

Per block 1208, some embodiments send at least one of: the received first stretch sensor data, the received second stretch sensor data, the visual, and/or the score to a user device for presentation. For example, referring to FIG. 18, the wearable article processing system 1808 may transmit, over the network 1806, the data 1805 to the user device 1802. Responsively, the user device 1802 presents or displays the first stretch senor data, the second stretch sensor data, the visual, and/or the score.

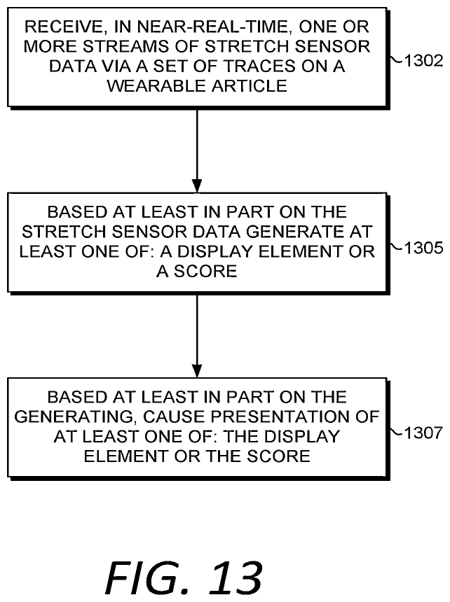

FIG. 13 is a flow diagram of an example process 1300 for causing presentation of a display element or score based on processing one or more streams of near-real-time stretch sensor data, according to some aspects. Per block 1303, some embodiments receive, in near-real-time, one or more streams of stretch sensor data via a set of traces on a wearable article. A data stream includes a series of data elements, typically ordered in time. Streaming data refers to data which is continuously flowing from a source system (e.g., the wearable article 300) to a target (e.g., the wearable article processing system 1808). Streaming data architecture allows aspects to receive, store, enrich, and/or analyze this flowing data in near-real-time as it is generated by the wearable article. For example, each time a mechanical stimulus is applied to a trace of a wearable article over a sequence of time, a trace generates a corresponding stretch sensor value, and the wearable article simultaneously (or responsively) transmits (e.g., via an antenna) such stretch sensor value to the wearable article processing system 1808 for the sequence of time. In this way, the wearable article processing system 1808 receives the stretch sensor data in “near-real-time” relative to the time at which the traces have generated such stretch sensor data.

Per block 1305, based at least in part on the stretch sensor data, some embodiments generate at least one of: a display element or a score. For example, based on a portion of the stream of stretch sensor data exceeding a threshold, some embodiments determine that the fit score is X. In some embodiments, block 1305 includes all the functionality as described with respect 1206 of FIG. 12. Per block 1307, based at least in part on the generating, particular embodiments cause presentation of at least one of: the display element or the score. For example, the display element can include any portion of the shoe recommendation 111 of FIG. 1B, any indicia (e.g., the fit score) in 211 of FIG. 2, the model of the foot 702 in FIG. 7B, or any portion of the screenshot 1100 of FIG. 11.

In some embodiments, a data stream management system (DSMS) is responsible for at least partially performing the process 1300. A DSMS, for example, includes a data ingestion layer that handles the flow or stream of stretch sensor data by data flow control, buffering the data, and routing it. In another example, the DSMS can include a query layer that generates queries for querying and analyzing stored data streams.

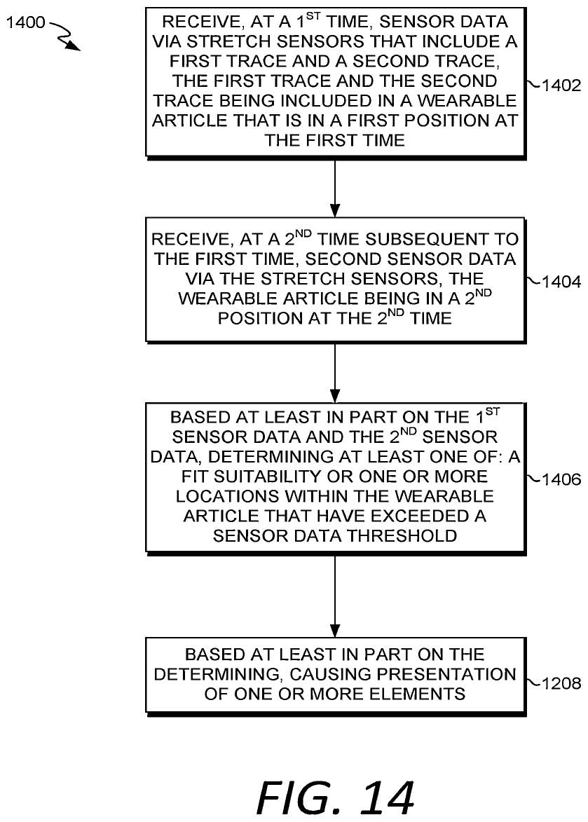

FIG. 14 is a flow diagram of an example process 1400 for determining fit or whether sensor data has exceeded a threshold, according to some aspects. Per block 1402, some aspects receive, at a first time, first sensor data via a plurality of stretch sensors that include at least a first trace and a second trace. The first sensor data indicates a first data value of the first trace and the second trace. For example, a microcontroller can receive, from an analog-to-digital converter, a digital sensor value indicating the quantity of resistance experienced by one or more portions of the trace. The first trace and the second trace are included in a wearable article. For example, the first trace and second trace can include the trace 304-1 of FIG. 3 and another trace, which is incorporated into the base layer 502 or non-conductive layer 504 of the sock structure 300. The wearable article is in a first position at the first time. For example, the sock structure 300 can be in a heel-strike position, as illustrated in FIG. 9A, which indicates that corresponding portions of the traces are measuring corresponding sensor data, such as resistance.

In some aspects, the first trace (or set of traces) and the second trace (or set of traces) overlap with each other, such as illustrated in FIG. 5. To “overlap” as described herein means to cross in position or orientation at any suitable angle and without respect to whether the traces touch or abut with each other. For example, the set (i.e., one or more) of traces 304-1 through 304-4 overlap with the set of traces 304-5 through 304-8 even though there is a non-conductive layer 504 between these sets of traces such that they do not touch. In some aspects, such traces overlap with each other in any suitable orientation, such as at 90 degrees relative to each other or have a perpendicular orientation so as to create a “grid” structure or pattern, as illustrated by the traces 304-1 through 304-8. In other aspects, such traces overlap at a 45 degree angle (plus or minus 5 degrees) such that the pattern is a “fish net,” diamond, or triangle pattern.

In some aspects, each trace is configured to convert mechanical stimuli into one or more electrical signals. “Mechanical” or “physical” stimuli refers to any suitable mechanical physical stimulus that a trace is experiencing, either through direct contact with an object (e.g., the ground, helmet, or shoe) that causes the physical stimulus or indirect contact (e.g., via an electric field propagated by a capacitor sensor) with an object that causes the physical stimulus. For example, in response to a trace experiencing a particular stress, strain, deformation, or force due to the trace (and by implication wearable article) being pressed against a ground surface, each trace can output a directly proportional sensor value, such as a resistance value, pressure value, or the like, which indicates a degree at which trace experienced the particular stimuli. In various aspects, the wearable article is configured to conform to a human body part, such as a hand, torso, head, or feet. To “conform” means to at least partially attach to or fit. For example, a human foot is configured to fit into a sock structure. In another example, a wrist band or knee brace is configured to fasten or attach to a wrist or knee.

In some aspects, in order to receive sensor data, as described with respect to blocks 1404 and 1406, a processor is communicatively coupled to the plurality of stretch sensors. A processor that is “communicatively” coupled to a stretch sensor means that the processor can communicate with the stretch sensor, whether through a wireless protocol (e.g., BLUETOOTH) or wired protocol. For example, the processor can be external or outside a wearable article and the stretch sensors can provide data through a bus on-chip, to a network interface corresponding to a BLUETOOTH protocol so that the network interface can wirelessly transmit, via an antenna, the sensor data to another antenna that is included in a computing device that houses the processor. In another example, the processor is connected to the stretch sensors, via a bus, and is included in the wearable article for localized communication. In another example, external lead lines or signal carriers that are external to or outside of the wearable article but physically connected to a processor external to the wearable device can be physically connected to the traces such that the traces provide their sensor data through the external leads to the processor.

A “stretch sensor” as described herein refers to any suitable sensor that converts, represents, or indicates mechanical stimuli to electrical signals (e.g., an Ohm signal). These sensors need not only measure “stretch” or even measure stretch at all. For example, one or more stretch sensors can include at least one of: a capacitive sensor, a resistive sensor, and piezoresistive sensor. The first sensor data value and the second sensor data value includes one or more of: a resistance value as detected by the resistive sensor, a capacitance value as detected by the capacitive sensor, and a dielectric value as detected by the piezoresistive sensor. Dielectrics are typically insulators that do not allow current to flow or are not conductors. Piezoelectricity is a property of certain dielectric materials to physically deform in the presence of an electric field, or conversely, to produce an electrical charge when mechanically deformed.

Per block 1404, some aspects receive, at a second time subsequent to the first time, second sensor data indicating a second sensor value of the first trance and the second trace. The wearable article (e.g., and the corresponding traces and human body part) is in a second position at the second time. For example, the wearable article can be in a position corresponding to a swing phase, heel-of, mid-stance, or any other gait stance. In an illustrative example, a processor can receive a second resistance value from each trace fastened to the wearable article as measured by a resistance sensor. In an illustrative example at a high level, the first sensor value can be included in the sensor values when the wearable article 904 is in its position as illustrated in FIG. 9A. And the second sensor value can be included in the sensor values when the wearable article 904 is in its position as illustrated in FIG. 9B.

Per block 1406, based at least in part on the first sensor data and the second sensor data, some aspects determine at least one of: a fit suitability associated with the wearable article, and one or more locations within the wearable article that have exceeded (or have fallen outside of or have met) a sensor data threshold (e.g., an resistance or capacitor value Y). For example, regarding the “fit suitability,” the wearable article can be a sock structure configured to be worn over a human foot and the sock structure is configured to be placed in a shoe. In some aspects, the plurality of stretch sensors include a capacitive sensor and another second sensor (e.g., a resistance sensor). Accordingly, the determining of the fit suitability associated with the wearable article includes determining whether the human foot fits the shoe based on the capacitive sensor detecting an inside portion of the shoe (e.g., via propagating an electric field to detect an interior surface of the shoe) and the second sensor can detect deformation characteristics of a corresponding portion of the first trace and the second trace. Examples of this are described with respect to FIGS. 9A and 9B and some aspects incorporate the functionality as described with respect to FIGS. 9A and 9B.

In some aspects, the determining of the one or more locations within the first trace or second trace (or by implication the wearable article) that have exceeded the sensor data threshold includes determining that the corresponding portion of the first trace and the second trace has exceeded a pressure threshold. In this way, for example, aspects can cause presentation of heat map elements (such as hot spot 1104 of FIG. 11) that indicate the corresponding portion exceeding the pressure threshold and other portions of the first trace or second trace that do not exceed the pressure threshold (e.g., “cool spots” indicated in blue).

Based at least in part on the first sensor data and the second data for the first trace and the second trace (and/or other sets of traces), some aspects generate a three-dimensional model of the human body part during a time sequence corresponding to the first time and the second time. For example, particular aspects can generate a 3D model of the human foot 702, as illustrated and described with respect to FIG. 7B. In some aspects, however, the “time sequence” corresponds to a video or model sequence of various video or model frames such that the 3D model represents a continuous frame-by-frame model between two time stamps (the first time and the second time) such that the 3D model illustrates movement (e.g., in near-real-time relative to human body movement) of the wearable article over the time sequence. For example, the 3D model can illustrate various gait phases in a model sequence, such as heel-strike, mid-stance, toe-off, and heel-of and corresponding “hot spots” during such sequence that indicate which areas of the foot or traces are associated with sensor data values that have exceeded a threshold. In some aspects, such 3D model is included in a user interface or other display element, such as the screenshot 1100 of FIG. 11.

In some aspects, block 1406 includes detecting a size (e.g., according to the U.S. or international shoe size conversion table, such as size 10) or dimensions (e.g., length, width, and height) of the foot (or every portion of the foot) based on at least one of the first sensor data and the second sensor data. For example, this can include the functionality as described with respect to FIG. 7A and FIG. 6. Such size indications can be presented at presentation elements, such as user interface indicia. For example, such indication can include “the current shoes do not fit the wearer” as illustrated in FIG. 11.

In some aspects, block 1406 can additionally or alternatively include other determinations, such as shoe design recommendations or activity recommendations. For example, based on the traces indicating that pressure exceeded a threshold only at the heel portion of a sock structure or shoe, particular aspects can recommend that a heel portion of the shoe be reinforced with more cushion, rubber, or actually recommend a specific predetermined shoe design. In some aspects, such design recommendation is based on using a machine learning model, such as the neural network 805 where, for example, training sensor data is labeled with specific design choices and the model can learn weights corresponding to the features or sensor data values associated with the label. In an illustrative example of an activity recommendation, particular aspects can recommend that a particular shoe is recommended for basketball but not football due to the specific stretch sensor readings being close to a basketball profile (which includes thresholds associated with such readings). In some aspects, as discussed above, such activity recommendation is based on using a machine learning model, such as the neural network 1005 where, for example, training sensor data is labeled with specific activities and the model can learn weights corresponding to the features or sensor data values associated with the label.

Per block 1408, based at least in part on the determining, some aspects cause presentation (e.g., display and/or utterance audio data of a voice assistant) of one or more elements. For example, the one or more elements may include one or more user interface elements of a user interface. In an illustrative example, based at least in part on the first sensor data and the second sensor data, some aspects generate a heat map that includes a digital model (e.g., FIG. 7B) of the human body part during a time sequence corresponding to the first time and the second time. The heat map further includes an element (e.g., hot spot 1104) that indicates, over a portion of the digital model, a corresponding location within the first trace or second trace that has exceeded the sensor data threshold. For example, the “one or more elements” can include the heat map 1102 or any other element in FIG. 11.

In some aspects, the one or more elements includes one or more shoe recommendations for a user to wear based on the sensor data. For example, the shoe recommendations can be a recommendation for a brand and model (or make/category within the shoe brand) of a shoe. In some aspects, such shoe recommendation is based on using a machine learning model, such as the neural network 1005 where, for example, training sensor data is labeled with specific brands and models and the neural network 1005 can learn weights corresponding to the features or sensor data values associated with the label.

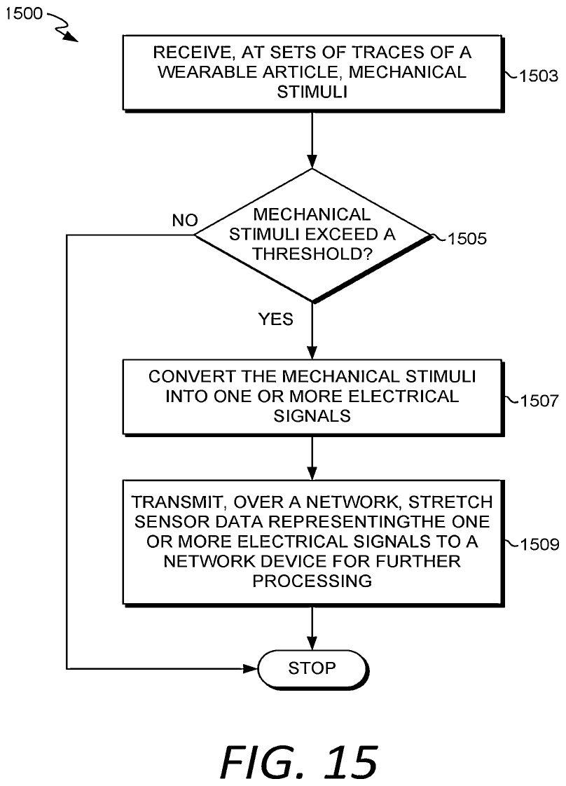

FIG. 15 is a flow diagram of an example process 1500 for transmitting stretch sensor data representing electrical signals to a network device for further processing, according to some aspects. In some embodiments, the process 1500 represents the functionality as performed by a wearable article, such as the wearable article 300 of FIG. 3. Per block 1503, the wearable article receives, at sets of traces, mechanical stimuli. “Mechanical stimuli” refers to any suitable mechanical physical stimulus that a trace is experiencing, either through direct contact with an object (e.g., the ground, helmet, or shoe) that causes the physical stimulus or indirect contact (e.g., via an electric field propagated by a capacitor sensor) with an object that causes the physical stimulus. A mechanical stimulus, for example, can be a simple finger touch of a trace or holding a particular object at a certain distance away from the trace (e.g., either inside or outside of an emitted electrical field of a capacitor sensor).

Per block 1508, the wearable article determines whether the stimulus exceeds a threshold (e.g., a resistance or capacitance threshold). If no, then the process 1500 stops. If yes, then the wearable article converts the mechanical stimuli into one or more electrical signals. For example, in response to a trace experiencing a particular stress, strain, deformation, or force due to the trace (and by implication wearable article) being pressed against a ground surface, each trace can output a directly proportional electrical signal, such as a resistance signal, pressure signal, or the like, which indicates a degree at which trace experienced the particular stimuli.

Per block 1509, the wearable article transmits, over a network (e.g., the network 1806 of FIG. 18), stretch sensor data representing the one or more electrical signals to a network device for further processing. For example, in response to the conversion at block 1502, a processor within the wearable article may first cause an analog-to-digital converter in the wearable article to convert the raw one or more electrical signals to digital data (i.e., the stretch sensor data). The processor may then transmit, via an on-chip bus, such stretch sensor data to a network interface, which includes an antenna for transmitting the stretch sensor data over the network to a network device, such as a cloud node or a server for further processing. Such cloud node or server may perform functionality as described, for example, with respect to the processes 1200 of FIG. 12, 1300 of FIG. 13, and/or 1400 of FIG. 14.

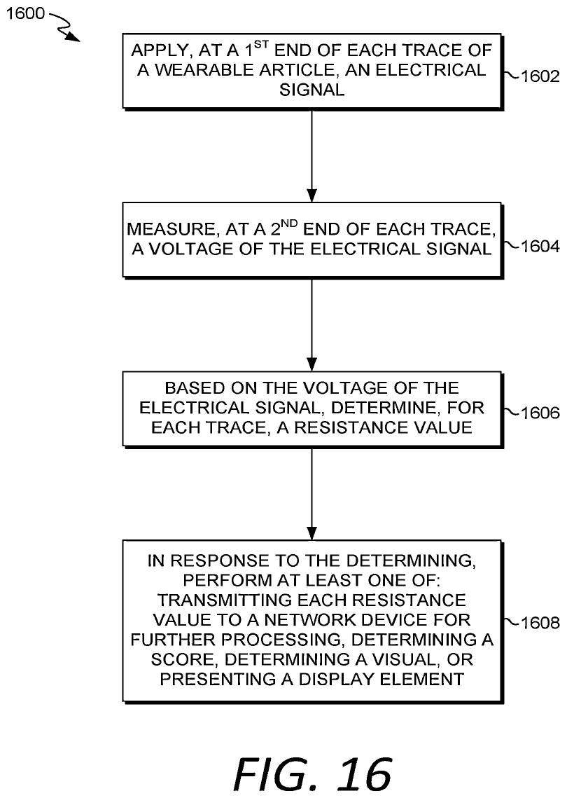

FIG. 16 is a flow diagram of an example process 1600 for determining a resistance value for each trace based on a voltage, according to some aspects. In some aspects, the process 1600 represents taking measurement data from a wearable article at rest to determine attributes, such as foot geometry, size, or the like to build a model, as described with respect to FIGS. 7A and 7B. Per block 1602, a wearable article applies, at a first end of each trace of a wearable article, an electrical signal. For example, a processor within the wearable article may apply an electrical signal through each trace in parallel at a first voltage (V1).

Per block 1604, the wearable article measures, at a second end of each trace, a voltage (V2) of the electrical signal. For example, each trace may output the electrical signal at the second end, which is at a second voltage, and a coupled bus may transmit such output to the processor of the wearable article.

Per block 1606, the wearable article determines, for each trace, a resistance value based on the voltage of the electrical signal. For example, the processor may determine the resistance value via the formula:

(V1−V2)=IR

Where I=current and R=resistance. V1, V2, and I are known, so aspects can derive R for each trace (“R2”).

Per block 1608, in response to the determining at block 1606, particular aspects perform at least one of: transmitting each resistance value to a network device for further processing, determining a score, determining a visual, or presenting a display element. In some aspects, block 1608 includes the functionality as described with respect to FIG. 1206 of FIG. 12

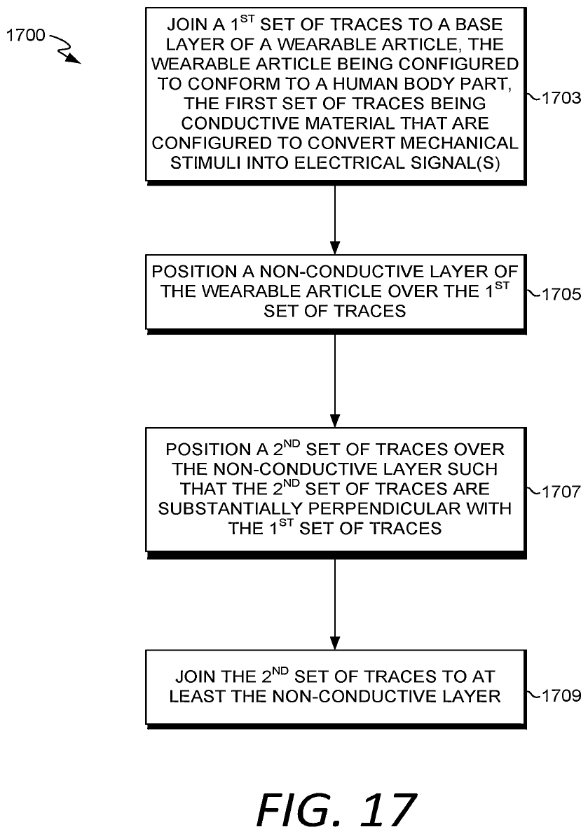

FIG. 17 is a flow diagram of an example method of manufacturing a wearable article, according to some aspects. In some aspects, FIG. 17 represents manufacturing the wearable article 500, as illustrated in FIG. 5. Per step 1703, some aspects (e.g., a knitting machine or sewing machine) join a first set of traces (e.g., the traces 304-1 through 304-4) to a base layer (e.g., the base layer 506 of FIG. 5) of a wearable article. The wearable article is configured to conform to a human body part. The first set of traces being conductive material that are configured to convert mechanical stimuli into one or more electrical signals. To “join” as described herein means to stitch, fasten, or otherwise couple two articles together. For example, joining can include or mean to sew, knit, weave, bond, join in a non-woven manner, or the like.

Per step 1705, aspects can position a non-conductive layer (e.g., the non-conductive layer 504) of the wearable article over the first set of traces. In these instances, the non-conductive layer is placed over the first set of traces such that the non-conductive layer is on top of and abutting the first set of traces. Per step 1707, aspects position a second set of traces (e.g., the horizontal traces 304-5 through 304-8) over the non-conductive layer such that the second set of traces are substantially perpendicular (plus or minus 5% of a 90 degree angle) with the first set of traces. In these instances, the second set of traces are placed over the non-conductive layer such that second set of traces are on top of and abutting the non-conductive layer. In some aspects, the second set of traces need not be positioned substantially perpendicular but can be positioned at any suitable angle, such as at a 45 degree angle (plus or minus 5%) relative to each other, or any other suitable angle.

Per step 1709, some aspects join the second set of traces to at least the non-conductive layer. Some aspects additionally or alternatively join the second set of traces to the first set of traces and/or the base layer. Some aspects alternatively or additionally join the non-conductive layer with the first set of traces and/or the based layer. In some aspects, the wearable article includes an outer layer that is positioned on top of the second set of traces, where the outer layer is the outermost layer that is visible to a wearer or environment such that no traces are viewable by a wearer. In these instances, the outer layer can be joined to the second set of traces, the non-conductive layer, the first set of traces, and/or the base layer.

In some instances, the “joining” as described in FIG. 17 is performed by an article production machine and/or in combination with a human. In some aspects, the article production machine is an automated knitting machine or any other machine capable of producing a wearable article. In aspects in which the article production machine is a knitting machine, the knitting machine may be a flat knitting machine, such as a flat V-bed knitting machine with a front needle bed and a back needle bed, for example. The knitting machine may form knitted components by needles from a single needle bed or by needles from both needle beds. The knitting machine may comprise and/or be coupled to one or more computing devices. The computing device(s) may accept computerized knitting instructions, and the knitting machine may automatically form a knitted component based on the computerized knitting instructions.

### Example Computing Environment

FIG. 18 is a block diagram illustrating an example computing environment 1800 for determining fit or other attributes associated with a wearable article, according to some aspects. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

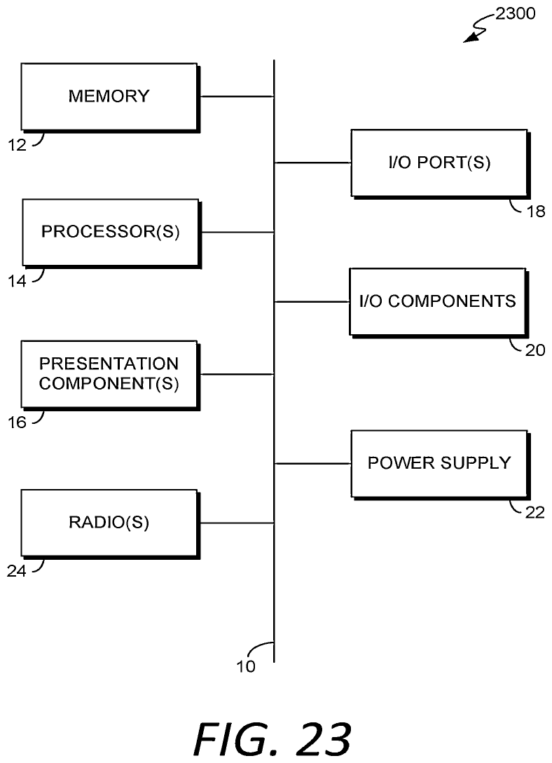

The computing environment 1800 is an example of a suitable architecture or operating environment for implementing certain aspects of the present disclosure. Among other components not shown, the computing environment 1800 includes a user device 1802, a wearable article 1804, and a wearable article processing system 1808. Each of the user device 1802, wearable article 1804, and the wearable article processing system 1808 can comprise one or more computer devices, such as the computing device 2300 of FIG. 23, discussed below. As illustrated in FIG. 18, the user device 1802, the wearable article 1804, and wearable article processing system 1808 can communicate via a network 1806, which can include, without limitation, one or more local area networks (LANs) and/or wide area networks (WANs). Such networking environments are commonplace in offices, enterprise-wide computer networks, intranets, and the Internet. It should be understood that any number of client devices and server devices can be employed within the computing environment 1800 within the scope of the present technology. Each can comprise a single device or multiple devices cooperating in a distributed environment. For instance, the wearable article processing system 1808 can be provided by multiple server devices or cloud nodes collectively providing the functionality of the wearable article processing system 1808 as described herein. Additionally, other components not shown can also be included within the network environment. In some aspects, the wearable article processing system 1808 is included in the user device 1802.

The user device 1802 can be a client device on the client side of computing environment 1800, while the wearable article processing system 1808 can be on the server side of computing environment 1800. The wearable article processing system 1808 can comprise server-side software designed to work in conjunction with client-side software on the user device 1802 so as to implement any combination of the features and functionalities discussed in the present disclosure. For instance, the user device 1802 can include an application for interacting with the wearable article processing system 1808. The application can be, for instance, a web browser or a dedicated application for providing functions, such as those described with respect to FIG. 11. This division of computing environment 1800 is provided to illustrate one example of a suitable environment, and there is no requirement for each implementation that any combination of the user device 1802 and the wearable article processing system 1808 remain as separate entities. While the computing environment 1800 illustrates a configuration in a networked environment with a separate user device and wearable article processing system, it should be understood that other configurations can be employed in which components are combined. For instance, in some configurations, a user device can also provide capabilities of the technology described herein.

The user device 1802 can comprise any type of computing device capable of use by a user. For example, in one aspect, the user device can be the type of computing device 2300 described in relation to FIG. 23 herein. By way of example and not limitation, the user device 1802 can be embodied as a personal computer (PC), a laptop computer, a mobile or mobile device, a smartphone, a tablet computer, a smart watch, a wearable computer, handheld communications device, gaming device or system, entertainment system, vehicle computer system, embedded system controller, appliance, consumer electronic device, workstation, or any combination of these delineated devices, or any other suitable device. A user can be associated with the user device 1802 and can interact with the wearable article processing system 1808 via the user device 1802.

The wearable article processing system 1808 is configured to receive the sensor data input 1818 from the wearable article 1808 (or more precisely the stretch sensors of the wearable article) in order to interpret the sensor input data 1818 (via the fit detection component 1810) and provide corresponding outputs 1805 to the user device 1802 (via the model generation component 1812). In some aspects, the wearable article processing system 1808 performs the processes 1200, 1300, and/or 1400 as described with respect to FIGS. 12, 13, and 14. In some aspects, the wearable article 1804 represents any wearable article described herein, such as the sock structure 300 of FIG. 3 or the head covering 400 of FIG. 4. In some aspects, the sensor data input 1818 represents any suitable sensor data values, such as resistance, capacitance, or piezoelectric values.

The fit detection component 1810 is generally responsible for interpreting the sensor data input 1818 in any suitable way, one example being determining if a shoe fits a foot. In some aspects, the fit detection component 1810 includes any of the functionality as described with respect to FIGS. 12, 13, and/or 14. For example, the fit detection component 1810 can determine a fit suitability associated with the wearable article 1804, one or more locations within the wearable article 1804 that have exceeded a sensor data threshold, a comfort score, a shoe design recommendation, a shoe brand/model recommendation, and/or an activity recommendation, as described herein. To interpret such sensor data, in some aspects, the fit detection component 1810 includes or uses the neural network 1005, as described with respect to FIG. 10.

The model generation component 1812 is generally responsible for generating or determining one or more elements (e.g., visuals) for presentation at the user device 1202. For example, in some aspects, the model generation component 1812 generates a 3D model of a foot, such as the model 702 of the foot in FIG. 7B. In another example, the model generation component 1812 causes presentation (e.g., by sending a communication signal, via the network 1806, to the user device 1802) of one or more user interface elements of the screenshot 1100 of FIG. 11, such as the hotspot 1104 of FIG. 11. The model generation component 1812 can cause presentation of any other user interface element as described herein and can include the functionality as described with respect to 1408 of FIG. 14.

The wearable article processing system 1808 can be implemented using one or more server devices, one or more platforms with corresponding application programming interfaces, cloud infrastructure, and the like. While the wearable article processing system 1808 is shown separate from the user device 1802 and the wearable article 1804 in the configuration of FIG. 18, it should be understood that in other configurations, some or all of the functions of the wearable article processing system 1808 can be provided in the user device 1802 and/or the wearable article 1804. For example, in some aspects the fit detection component 1810 and/or the model generation component 1812 is logic included on-chip or within the wearable article 1804.

In one aspect, the functions performed by components of the wearable article processing system 1808 are associated with one or more applications, services, or routines. In particular, such applications, services, or routines can operate on one or more user devices or servers, be distributed across one or more user devices and servers, or be implemented in the cloud.

Moreover, in some aspects, these components of the wearable article processing system 1808 can be distributed across a network, including one or more servers and client devices, in the cloud, and/or can reside on a user device. Moreover, these components, functions performed by these components, or services carried out by these components can be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, although functionality is described herein with regards to specific components shown in example computing environment 1200, it is contemplated that in some aspects, functionality of these components can be shared or distributed across other components.

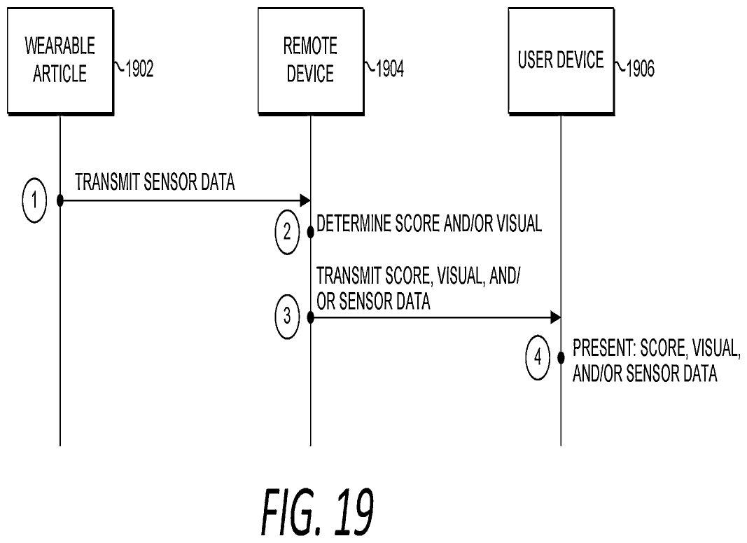

FIG. 19 is a sequence diagram illustrating a wearable article, a remote device, and a user device performing different functionalities, according to some aspects. At a first time, the wearable article 1902 (e.g., the wearable article 300 of FIG. 3) transmits sensor data (e.g., via an antenna and an on-chip network interface card) to a remote device 1904. The remote device 1904, or any “remote device” described herein, refers to any external device that is outside or not part of the wearable article 1902 or the user device 1906. For example, the remote device 1904 can be any suitable network device or host, such as a cloud node, a server, a switch, a gateway device, a base station or any associated component, a router, or the like. In some aspects, the remote device 1904 or any other remote device described herein includes the wearable article processing system 1808 of FIG. 18.

In response to the remote device 1904 receiving the transmitted sensor data, per step 2, the remote device 1904 determines at least one of a score or visual. In some aspects, this includes the functionality as described with respect to block 1206 of FIG. 6. Per step 3, the remote device 1904 then transmits the score, the visual and/or the sensor data to a user device 1906. Per step 4, the user device 1906 then presents (e.g., displays) the score, visual, and/or sensor data.

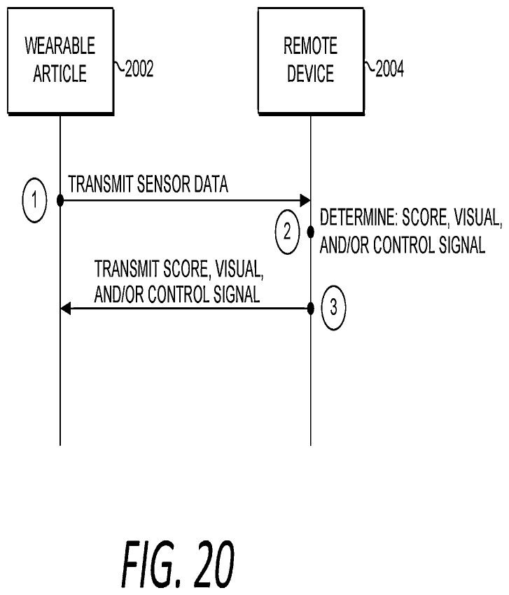

FIG. 20 is a sequence diagram illustrating a wearable article and a remote device performing different functionalities, according to some aspects. At step 1, the wearable article 2002 first transmits sensor data to the remote device 2004. For example, the wearable article 2002 may convert mechanical stimuli into one or more electrical signals indicative of one or more stretch sensor data, such as resistance values. The wearable article 2002 may then transmit such stretch sensor data to the remote device 2004 per step 1.

Per step 2, the remote device 2004 then determines at least one of a score, a visual, and/or a control signal. In some aspects, step 2 includes the functionality as described with respect to block 1206 of FIG. 12. To determine a control signal, the remote device 2004 may determine what control signal to transmit to the wearable article 2002 to cause some specific tangible output at the wearable article 2002. For example, the remote device 2004 may determine that it needs to send a control signal to activate a Light Emitting Diode (LED) at the wearable article 2002. Per step 3, the remote device 2004 transmits the score, visual, and/or control signal to the wearable article 200. For example, the control signal may cause the LED to output a particular color or lighting pattern, which is indicative that the sensor data has exceeded a threshold or any other indicator associated with the score, such as shoe fit, or the like. In another example, the control signal may be audio feedback that is indicative of the same.

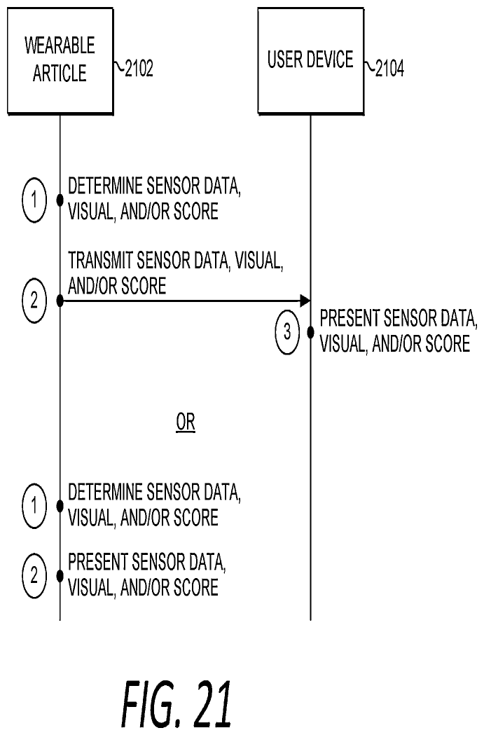

FIG. 21 is a sequence diagram illustrating a wearable article and a user device performing different functionalities, according to some aspects. At step 1, the wearable article 2102 determines sensor data, a visual, and/or a score. In some aspects, step 1 includes the functionality as described with respect to block 1206 of FIG. 12. Per step 2, the wearable article 2102 then transmits the sensor data, visual, and/or the score to a user device 2104. At step 3, the user device 2104 then responsively presents (e.g., displays or provides audio feedback of) the sensor data, the visual and/or the score.

In an alternative aspect, the wearable article 2102 performs all the functionality such that the user device 2104 is not needed as illustrated in FIG. 21. For example, per step 1, the wearable article 2102 can determine sensor data, a visual, and/or a score. And at step 2, the wearable article 2102 can additionally present the sensor data, visual, and/or score. In these aspects, for example, the wearable article 2102 can include a display device (e.g., an LCD screen) and/or audio device in order to present such information.

### Example Computing Devices

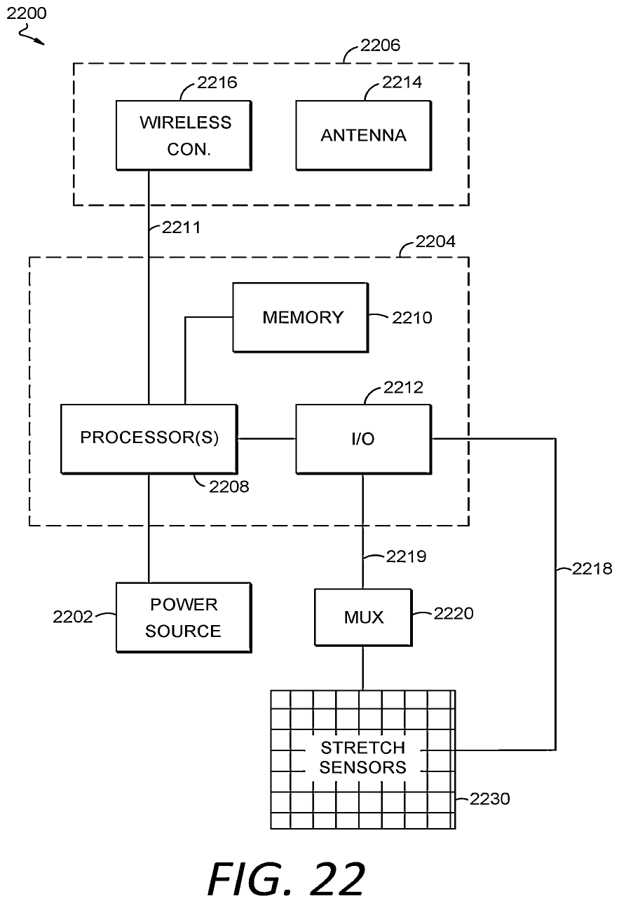

FIG. 22 is a block diagram 2200 of the electronics of any wearable article described herein (e.g., the wearable article 300 of FIG. 3), according to some aspects. Although FIG. 22 illustrates various components that are included within a wearable article, in some aspects, some or each of the components are not part of the wearable article. For example, in some aspects, the electronics of a wearable article only includes the stretch sensors 2230 and/or the wireless communication block 2206 while the other components are hosted at a remote device, such as the wearable article processing system 2808 of FIG. 18. The block diagram 2200 includes a wireless communication block 2206, a control block 2204, a power source 2202, a multiplexer (MUX) 2220, and a set of traces 2230 (e.g., a set of stretch sensors).

The power source block 2202 includes a source of DC power, such as a battery, a super capacitor, and so forth, sufficient to provide power to the various other electronics. A battery may be a rechargeable battery or may be replaceable. Additionally or alternatively, the power source block 2202 may include any of a variety of further power sources, including a piezoelectric generator or other source of power that may generate power though the movement or conventional use of the wearable article. The power source block 2202 optionally includes additional componentry to boost or otherwise shift the power output of the source of DC power, such as a boost converter in an example, the power source block 2202 includes a lithium ion battery configured to deliver between 3.0 and 4.2 Volts and a live (5) Volt boost converter.

The control block 2204 receives power from the power source block 2202 and controls the operation of the wireless communication block 206 and signals transmitted and received from the traces 2230 (or stretch sensors). The control block 2204 include a processor 2208, such as a microcontroller, an electronic memory 2210, such as random-access memory (RAM) or flash memory or any suitable electronic memory known in the art, and an input/output block 212, among a variety of other components that may be desired or utilized. In an example, the control block 2204 is a single system or system on a chip (e.g., a PCB substrate with circuitry components). In an example, the control block 2204 includes an ATmega32U4 microcontroller by Atmel Corporation as the processor 2208 and related circuitry and/or by Lenoardo microcontroller board by Arduino Corporation, or any suitable controller or controller system. In some aspects, the processor 2208 performs the processes 1200, 1300, 1400, 1500, and/or 1600 of FIGS. 12, 13, 14, 15, and/or 16.

When a stretch sensor, individual trace of 2230, or the set of traces 2230 outputs a signal to the input/output block 2212 of the control block 1304, the input/output block 2212 formats the signal received form the trace and forwards the signal to the processor 2208. The processor 2208 assesses the signal from the input/output block 2212 for various properties as desired, including, but not limited to, a time at which the output signal was sensed and a duration of the output signal. The processor 2208 may store such properties in the electronic memory 2210 and/or act on the properties as appropriate.

The wireless communication block 2206 (e.g., a network interface) includes one or more wireless antennas 2214 and a wireless controller 2216. The wireless antennas 2214 may each be configured to communicate according to a different wireless modality, such as various versions of Bluetooth, near-field communications (NEC), ultra-high frequency (UHF), and so forth. Each wireless antenna 2214 may be configured to communicate in one band or across multiple bands. The wireless controller 2216 is configured to communicate according to the various wireless modalities corresponding to the one or more antennas 2214. The wireless controller 2216 may be a unitary device or may be multiple individual controllers each separately configured to communicate according to a different modality supported by the various antennas. In a non-limiting example, the wireless communication block 2206 includes a single antenna 2214 configured to communicate, sensor data to an external device, such as the wearable article processing system 1808 of FIG. 18, according to a Bluetooth standard or any other standard.

The wireless communication block 2206 is configured to communicate via the various modalities with one or more external devices which are not themselves part of the wearable article. The external devices may be mobile devices, such as mobile phones (e.g., user device 2802), smartphones, personal digital assistants (PDAs), mobile music or media players, and so forth. The external device additionally or alternatively may be stationary or generally stationary, such as a race tracker or base station. The wireless communication block 2206 may pair with a given external device according to conventional pairing mechanisms related to the given external device so as to establish a communication link between the wearable article and the external device.

In various examples, the control block 2204 includes as a separate component or implements with the processor 2208 and/or the input/output block 2212 implements an analog-to-digital converter (ADC) and rate smoothing and/or filtering of the signals from the traces 2230. In various examples, the ADC converts the input analog signal from approximately zero (0) Volts to approximately five (5) Volts to and eight-bit digital signal at a sampling rate of front approximately ten (10) Hertz to fifty (50) Hertz in an example, the sample rate is thirty (30) Hertz.

In various examples, the input output block 2212 and/or the processor 2208 utilizes a rolling weighted average of the digital output from the ADC for each sensor data value received from a trace. In an example, the processor 2208 applies a rolling weighted average of 0.2 for a current output from the ADC for a pressure sensor and 0.8 for the previous rolling weighted average of the output of the pressure sensor. Thus, the current rolling weighted average for the output from a given pressure sensor is eighty (80) percent based on the previous average and twenty (20) percent based on the current output from the ADC for that pressure sensor. It is noted and emphasized that each stretch sensor may be assessed for its rolling weighted average separately and independently.

The block diagram 2200 further includes a mux 2220. Various aspects use the multiplexer (or “MUX”) 2220 to reduce the pin-count needed to measure the impedance or other physical stimuli of each the trace. In some aspects, the processor 2208 applies an electrical signal at a source voltage V1 to each trace, of the set of traces 2230, in parallel at a first end by first transmitting the signal through the bus 2218 into the first end of each trace. And then each trace outputs the voltage V2 at a second end, which is then forwarded to the MUX 2220 and then forwarded to the processor(s) 2208, via the bus 2219 (and/or the wireless communication block 2206 to transmit to the wearable article processing system 1808) for processing and interpretation. For example, the processor(s) 2208 can determine the resistance of each trace using Ohm's law based on the voltage, as described above. Additionally or alternatively, the processor(s) 2208 can then convert or interpret the resistance or other sensor data into other determinations, such as fit associated with the wearable article, wearable article comfort, wearable article design recommendations, and/or any suitable determinations as described with respect to block 1406 of FIG. 14. Additionally or alternatively, in some aspects, in response to determining the resistance (e.g., via Ohm's law) or other sensor value, the processor 2208 sends a signal along the bus 2211 to the wireless communication block 2206 to transmit to the wearable article processing system 1808 for further processing. For example, the antenna 2214 can transmit, over a wireless computer network, a request to an external remote r device a request to interpret or map the resistance value to a particular score. Such remote device can, for example, include the neural network 1005, such that the resistance values are provided as input into the model to generate different inference prediction scores.

Looking now to FIG. 23, computing device 2300 includes a bus 10 that directly or indirectly couples the following devices: memory 12, one or more processors 14, one or more presentation components 16, input/output (I/O) ports 18, input/output components 20, and an illustrative power supply 22. Bus 10 represents what may be one or more busses (such as an address bus, data bus, or combination thereof). Although the various blocks of FIG. 23 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventor recognizes that such is the nature of the art, and reiterates that the diagram of FIG. 23 is merely illustrative of an exemplary computing device that can be used in connection with one or more aspects of the present invention. Distinction is not made between such categories as “workstation,” “server,” “laptop,” “hand-held device,” etc., as all are contemplated within the scope of FIG. 23 and reference to “computing device.”

Computing device 2300 typically includes a variety of computer-readable media. Computer-readable media can be any available media that can be accessed by computing device 2300 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 2300. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media. In various aspects, the computing device 2300 represents the physical architecture of the user device 1802 or the wearable article processing system 1808 of FIG. 18.

Memory 12 includes computer-storage media in the form of volatile and/or nonvolatile memory. The memory may be removable, non-removable, or a combination thereof. Exemplary hardware devices include solid-state memory, hard drives, optical-disc drives, etc. Computing device 2300 includes one or more processors that read data from various entities such as memory 12 or I/O components 20. Presentation component(s) 16 present data indications to a user or other device. Exemplary presentation components include a display device, speaker, printing component, vibrating component, etc. In some aspects, the memory includes program instructions that, when executed by one or more processors, cause the one or more processors to perform any operations described herein, such as the processes 1200, 1300, 1400, 1500, and/or 1600 of FIGS. 12, 13, 14, 15, and/or 16 or any functionality described with respect to FIGS. 1 through 13.

I/O ports 18 allow computing device 2300 to be logically coupled to other devices including I/O components 20, some of which may be built in. Illustrative components include a microphone, joystick, game pad, satellite dish, scanner, printer, wireless device, etc. The I/O components 20 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1400. The computing device 2300 may be equipped with depth cameras, such as stereoscopic camera systems, infrared camera systems, RGB camera systems, touchscreen technology, and combinations of these, for gesture detection and recognition. Additionally, the computing device 2300 may be equipped with accelerometers or gyroscopes that enable detection of motion. The output of the accelerometers or gyroscopes may be provided to the display of the computing device 1400 to render immersive augmented reality or virtual reality.

As can be understood, aspects of the present invention provide for, among other things, generating proof and attestation service notifications corresponding to a determined veracity of a claim. The present invention has been described in relation to particular aspects, which are intended in all respects to be illustrative rather than restrictive. Alternative aspects will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub combinations are of utility and may be employed without reference to other features and sub combinations. This is contemplated by and is within the scope of the claims.

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The following clauses represent example aspects of concepts contemplated herein. Any one of the following clauses may be combined in a multiple dependent manner to depend from one or more other clauses. Further, any combination of dependent clauses (clauses that explicitly depend from a previous clause) may be combined while staying within the scope of aspects contemplated herein. The following clauses are examples and are not limiting.

The present technology has been described in relation to particular aspects, which are intended in all respects to be illustrative rather than restrictive. Alternative aspects will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the aspects depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Aspects described herein can be combined with one or more of the specifically described alternatives. In particular, an aspect that is claimed can contain a reference, in the alternative, to more than one other aspect. The aspect that is claimed can specify a further limitation of the subject matter claimed.

The subject matter of aspects of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, aspects of the present technology are described with reference to a distributed computing environment; however, the distributed computing environment depicted herein is merely exemplary. Components can be configured for performing novel aspects of aspects, where the term “configured for” can refer to “programmed to” perform particular tasks or implement particular abstract data types using code. Further, while aspects of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and sub combinations are of utility and can be employed without reference to other features and sub combinations. This is contemplated by and is within the scope of the claims.

What is claimed is:

1. A computer-implemented method comprising:
receiving, at a first time, first stretch sensor data via at least two overlapping sets of traces on a wearable article that is in a first position;
receiving, at a second time, second stretch sensor data via the at least two overlapping sets of traces on the wearable article that is in a second position;
determining at least one of a visual or score based on the received first and second stretch sensor data; and
sending at least one of: the received first stretch sensor data, the received second stretch sensor data, the visual, or an indication of the score to a user device for presentation.

2. The method of claim 1, wherein the determining includes determining the visual, the visual comprising data representing a heat map, the heat map includes a digital model of a human body part during a time sequence corresponding to the first time and the second time, and wherein the heat map further includes an element that indicates, over a portion of the digital model, a corresponding location within the at least two overlapping sets of traces that have exceeded a sensor data threshold.

3. The method of claim 1, wherein the determining includes determining the score, the score comprising at least one of: a fit score, a comfort score, a shoe recommendation score, or an activity recommendation score.

4. The method of claim 1, wherein the at least two overlapping sets of traces include at least one of: a capacitive sensor, a resistive sensor, and piezoresistive sensor, and wherein the first sensor data value and the second sensor data value includes one or more of: a resistance value as detected by the resistive sensor, a capacitance value as detected by the capacitive sensor, and a dielectric value as detected by the piezoresistive sensor.

5. The method of claim 1, wherein the determining of the score is based on determining whether a human foot fits a shoe based on a capacitive sensor included in the at least two overlapping sets of traces detecting an inside portion of the shoe.

6. The method of claim 1, wherein the determining of the score is based on determining that at least a portion of the at least two overlapping sets of traces has exceeded a pressure threshold, and wherein the determining of the visual includes determining data representing heat map elements that indicate the portion exceeding the pressure threshold and another portion of the at least two overlapping sets of traces that do not exceed the pressure threshold.

7. The method of claim 1, wherein the determining of the visual includes determining data representing a three-dimensional model of a human body part during a time sequence corresponding to the first time and the second time.

8. The method of claim 1, wherein the determining of the score is based on detecting a size or dimensions of a foot based on at least one of the first stretch sensor data and the second stretch sensor data.

9. A system comprising:
a wearable article that includes a plurality of stretch sensors, the plurality of stretch sensors comprising a first set of traces that overlap with a second set of traces, each trace being configured to convert mechanical stimuli into one or more electric signals, wherein the wearable article is configured to conform to a human body part; and
a processor communicatively coupled to the plurality of stretch sensors, wherein the processor is configured to perform operations comprising:
receiving, at a first time, first sensor data via the plurality of stretch sensors, the first sensor data indicates a first sensor value of each trace, wherein the wearable article is in a first position at the first time;
receiving, at a second time subsequent to the first time, second sensor data via the plurality of stretch sensors, the second sensor data indicates a second sensor value of each trace, wherein the wearable article is in a second position at the second time;
based at least in part on the first sensor data and the second sensor data, determining at least one of: a fit suitability associated with the wearable article, or one or more locations of the first set of traces and the second set of traces that have exceeded a sensor data threshold; and
based at least in part on the determining, causing presentation, at a user interface of a user device, of one or more user interface elements.

10. The system of claim 9, wherein the processor is configured to perform further operations comprising:
based at least in part on the first sensor data and the second set of data, generating a heat map that includes a digital model of the human body part during a time sequence corresponding to the first time and the second time, and wherein the heat map further includes an element that indicates, over a portion of the digital model, a corresponding location within the first set of traces and the second set of traces that has exceeded the sensor data threshold, and wherein the heat map is included in the one or more user interface elements of the user interface.

11. The system of claim 9, wherein the wearable article includes one of: an article of footwear, a head covering, a garment article, or a glove.

12. The system of claim 9, wherein the plurality of stretch sensors include at least one of: a capacitive sensor, a resistive sensor, and piezoresistive sensor, and wherein the first sensor data value and the second sensor data value includes one or more of: a resistance value as detected by the resistive sensor, a capacitance value as detected by the capacitive sensor, or a dielectric value as detected by the piezoresistive sensor.

13. The system of claim 9, wherein the wearable article is a sock structure configured to be worn over a human foot and the sock structure is configured to be placed in a shoe, and wherein the plurality of stretch sensors includes a capacitive sensor and a second sensor, and wherein the determining of the fit suitability associated with the wearable article includes determining whether the human foot fits the shoe based on the capacitive sensor detecting an inside portion of the shoe and the second sensor detecting deformation characteristics of a corresponding portion of the first set of traces and the second set of traces.

14. The system of claim 9, wherein the determining of the one or more locations within the first set of traces and the second set of traces that have exceeded the sensor data threshold includes determining that the corresponding portion of the first set of traces and the second set of traces has exceeded a pressure threshold, and wherein the one or more user interface elements include heat map elements that indicate the corresponding portion exceeding the pressure threshold and other portions of the first set of traces and the second set of traces that do not exceed the pressure threshold.

15. The system of claim 13, wherein the one or more user interface elements includes one or more shoe recommendations for a user to wear based on the capacitive sensor detection and the second sensor detection.

16. The system of claim 9, wherein the processor is configured to perform further operations comprising:
based at least in part on the first sensor data and the second sensor data for the first set of traces and the second set of traces, generating a three-dimensional model of the human body part during a time sequence corresponding to the first time and the second time, and wherein the one or more user interface elements include the three-dimensional model of the human body part.

17. The system of claim 9, wherein the human body part is a foot, and wherein the processor is configured to perform further operations comprising:
detecting a size or dimensions of the foot based on at least one of the first sensor data and the second sensor data, and wherein the one or more user interface elements include an indication of the size or dimensions of the foot.

18. A wearable article that includes a plurality of stretch sensors, the plurality of stretch sensors comprising a first set of traces that overlap with a second set of traces, each trace being configured to convert mechanical stimuli into one or more electric signals, wherein the wearable article is configured to conform to a human body part; and
a processor communicatively coupled to the plurality of stretch sensors, wherein the processor is configured to perform operations comprising:
receiving, at a first time, first sensor data via the plurality of stretch sensors, the first sensor data indicates a first sensor value of each trace, wherein the wearable article is in a first position at the first time;
receiving, at a second time subsequent to the first time, second sensor data via the plurality of stretch sensors, the second sensor data indicates a second sensor value of each trace, wherein the wearable article is in a second position at the second time;
based at least in part on the first sensor data and the second sensor data, determining one or more locations of the first set of traces and the second set of traces that have exceeded a sensor data threshold; and
based at least in part on the determining, causing presentation, at a user interface of a user device, of one or more user interface elements.

19. The wearable article of claim 18, wherein the wearable article includes one of: an article of footwear, a head covering, a garment article, or a glove.

20. The wearable article of claim 18, wherein the plurality of stretch sensors include at least one of: a capacitive sensor, a resistive sensor, and piezoresistive sensor, and wherein the first sensor data value and the second sensor data value includes one or more of: a resistance value as detected by the resistive sensor, a capacitance value as detected by the capacitive sensor, or a dielectric value as detected by the piezoresistive sensor.
